(19) United States
(12) Patent Application Publication
(10) Pub. No.: US 2015/0058140 A1
(43) Pub. Date: Feb. 26, 2015

(54) SYSTEMS AND METHODS FOR IN-APPLICATION OFFERS

(71) Applicant: Electronic Arts, Inc., Redwood Shores, CA (US)

(72) Inventor: Matthew Dixon, Stockholm (SE)

(73) Assignee: Electronic Arts, Inc., Redwood Shores, CA (US)

(21) Appl. No.: 14/064,028

(22) Filed: Oct. 25, 2013

Related U.S. Application Data
(60) Provisional application No. 61/868,473, filed on Aug. 21, 2013.

(51) Int. Cl. G06Q 30/02

(52) U.S. Cl. CPC G06Q 30/0277
USPC 705/14.73

(57) ABSTRACT

Various embodiments described herein facilitate presenting offers within an application, such as a video game, operating on a client system. The systems and methods of some embodiments may execute an application by a computing device having a screen, the first application having an application user interface being displayed on the screen. The system or method can then receive advertisement data and a link to an offer. The system or method can display the advertisement data a moving graphical container such it is moving across the screen (i.e., a moving graphical container) and over the application user interface. Once displayed, the system or method can await, and subsequently receive, user interaction with respect to the moving graphical container. The system or method can respond to the user interaction by navigating to a page using the link, the page including the offer.

### CROSS-REFERENCE TO RELATED APPLICATIONS

The present application claims priority from U.S. Provisional Patent Application Ser. No. 61/868,473, filed Aug. 21, 2013, entitled “POP THE OFFER,” which is incorporated herein by reference.

### BACKGROUND

1. Technical Field

The present invention(s) generally relate to providing offers and, more particularly, providing offers within an application, such as a video game.

2. Description of Related Art

Applications for mobile devices, particularly video games, have grown quite popular amongst mobile device users. As a result, mobile device applications also present an effective platform through which organizations, such as merchants and charities, can present application users with offers regarding products, services, and the like. The types of products and services, offered include those that are real in nature (e.g., retail product offered by an online merchant) and those that are virtual in nature (e.g., virtual currency useful in a virtual game economy). Additionally, what is offered can be free (e.g., on application offered for trial purposes) or for-purchase. For example, a video game user may be offered with virtual objects or currency, available for purchase and use in a particular video game. In another example, a video game user may be offered an opportunity to download and try another video game.

### SUMMARY

Various embodiments described herein provide for systems and methods that relate to providing offers and, more particularly, providing offers within an application, such as a video game, operating on a client system.

According to some embodiments, a system or method can execute an application by a computing device having a screen, where the first application has an application user interface being displayed on the screen. The system or method can then receive advertisement data and a link to an offer. The system or method can display the advertisement data a moving graphical container such it is moving across the screen (i.e., a moving graphical container) and over the application user interface. Once displayed, the system or method can await, and subsequently receive, user interaction with respect to the moving graphical container. The system or method can respond to the user interaction by navigating to a page using the link, the page including the offer. In some embodiments, responding to the user interaction may further comprise displaying animation of the graphical container. In various embodiments, responding to the user interaction may further comprise displaying animation of the advertisement data and the graphical container.

Depending on the embodiment, the advertisement data may comprise a graphical asset intended to visually represent an offer being advertised. In some instances, the graphical asset may be an image, an animation, a video, a slide show (e.g., set of images), or the like. Hereinafter, a graphical asset intended to represent an offer is also be referred to as an “advertisement asset.” Further, depending on the embodiments, the graphical container (which may contain the graphical asset) may be a bubble or a snowflake. Other examples of graphical containers include a bowling ball, a billiard ball, a beach ball, a snowflake, a cloud, a wooden crate, or an object with a parachute. A user interaction may comprise a user input received via a user input device coupled to a computing device, such a touch-enabled display, a keyboard, a mouse, a microphone, accelerometer, camera, or the like.

In some embodiments, the system or method can respond to the user interaction by navigating to the page using the link comprises responding to the user interaction by navigating to a website accessible by a network, the website including the page. In various embodiments, the system or method can respond to the user interaction by navigating to a store configured to facilitate redemption of a given offer. The store can include one configured to facilitate purchase of various products or services, including digital products such as an application or digital media (e.g., music, video, or books). In some embodiments, responding to the user interaction by navigating to the page using the link may comprise responding to the user interaction by navigating to a page associated with an electronic application store and the offer is associated with one or more applications.

For some embodiments, the advertisement data and the moving graphical container may be configured to not interact with the application user interface (e.g., as they move across the application user interface). The advertisement data and the graphical container may, for some embodiments, bounce off of graphical elements of the application user interface. Additionally, the advertisement data and the graphical container avoid portions of the application user interface. Further, in some embodiments, the advertisement data and the graphical container may bounce off another advertisement data and other graphical container

In various embodiments, the system or method can receive an indication from a user to drag the advertisement data and the graphical container from a first portion of the screen to an other and moving the advertisement data and the graphical container from the first portion of the screen to the other based on the indication. Additionally, in some embodiments, the system or method can receive a set of advertisements from a network, wherein the advertisement data is a part of the set of advertisements.

For various embodiments, the offer may be for a variety items, including of products, services, incentives, property interests, and the like. For example, the offer may include an invitation to download a game from an electronic application store.

Various embodiments provide for a computer program product comprising computer instruction codes configured to cause the computer system to perform various operations described herein.

Other features and aspects of various embodiments will become apparent from the following detailed description, taken in conjunction with the accompanying drawings, which illustrate, by way of example, the features of such embodiments.

### BRIEF DESCRIPTION OF THE DRAWINGS

Various embodiments are described in detail with reference to the following figures. The drawings are provided for purposes of illustration only and merely depict some embodiments. These drawings shall not be considered limiting of the breadth, scope, or applicability of embodiments.

FIG. 1 is a block diagram illustrating an example environment utilizing an in-application offer system in accordance with various embodiments.

FIG. 2 is a block diagram illustrating an example in-application offer client module in accordance with various embodiments.

FIG. 3 is a block diagram illustrating an example in-application offer system in accordance with various embodiments.

FIG. 4 is a flowchart illustrating an example method for providing an in-application offer in accordance with various embodiments.

FIG. 5 is a flowchart illustrating an example method for providing an in-application offer in accordance with various embodiments.

FIG. 6 is a block diagram illustrating an example system for providing an in-application offer in accordance with various embodiments.

FIG. 7 is a screenshot illustrating an example panel for managing options for application offers in accordance with various embodiments.

FIG. 8 is a screenshot illustrating an example panel for managing offers in accordance with various embodiments.

FIG. 9 is a screenshot illustrating an example panel for managing offer details in accordance with various embodiments.

FIG. 10 is a screenshot illustrating an example panel for managing offer restrictions in accordance with various embodiments.

FIG. 11 is a screenshot illustrating an example panel for managing offer-presentation options in accordance with various embodiments.

FIG. 12 is a screenshot illustrating an example panel for managing offer-presentation options in accordance with various embodiments.

FIG. 13 is a screenshot illustrating an example panel for managing application offers in accordance with various embodiments.

FIG. 14 is a screenshot illustrating an example panel for managing details regarding an application offer in accordance with various embodiments.

FIG. 15 is a screenshot illustrating an example of presenting an in-application offer over an application user interface in accordance with various embodiments.

FIG. 16 is a screenshot illustrating an example of presenting in-application offers over an application user interface in accordance with various embodiments.

FIG. 17 is a screenshot illustrating an example of presenting in-application offers over an application user interface in accordance with various embodiments.

FIG. 18 is a screenshot illustrating an example application store in accordance with various embodiments.

FIG. 19 is a block diagram illustrating an exemplary digital device that can be utilized in the implementation of various embodiments.

### DETAILED DESCRIPTION

Various embodiments described herein relate to providing offers and, more particularly, providing offers within an application, such as a video game. Some embodiments implement systems or methods for a cross-promotional or advertising tool configured to present offers, within an application through an offer user interface (also referred to herein as an “in-application offer user interface”). A system or method may, for example, utilize an offer user interface comprising bubbles, snowflakes, or the like as graphical containers for presenting offers over an application interface of an application, such as a video game. For some embodiments, the natural tendency or temptation of a user to interact with certain graphical containers (e.g., bubbles or snowflakes) may result in the offer user interface being fun or engaging to users, which may translate to desirable conversion rates for certain offers. As understood herein, conversion of an offer can include opening the details regarding the offer and redeeming the offer. For example, where bubbles are used as graphical containers for offers, a user may dragging and dropping bubbles on a touch-enabled display, causing bubbles to pop (e.g., by tapping on a bubble on a touch-enabled display), bouncing bubbles off the borders of the display or other bubbles, blowing on bubbles (e.g., blowing into a microphone), or the like.

According to some embodiments, a system or method can execute an application by a computing device having a screen, where the first application has an application user interface being displayed on the screen. The system or method can then receive advertisement data and a link to an offer. The system or method can display the advertisement data within a moving graphical container such the displayed advertisement data and the graphical container may move across the screen (i.e., a moving graphical container) and over the application user interface. Once displayed, in some embodiments, the system or method can await, and subsequently receive, user interaction with respect to the moving graphical container. The system or method can respond to the user interaction by navigating to a page using the link, the page including the offer. In some embodiments, responding to the user interaction may further comprise displaying animation of the graphical container (e.g., the advertisement data may include moving pictures or video). In various embodiments, responding to the user interaction may further comprise displaying animation of the advertisement data and the graphical container.

In some embodiments, the graphical container and advertisement data may float off the screen (e.g., off the application user interface). In one example, the graphical container and advertisement data may float off the screen after a predetermined period of time (e.g., if the user does not interact with the graphical container and advertisement data). In some embodiments, the user may purposefully move (e.g., drag) the graphical container and advertisement data off the screen to remove the graphical container and advertisement data.

As used herein, an offer will be understood to be one from an offerer to an offeree (e.g., a user at a client device) in accordance with various embodiments. Additionally, an offer will be understood to include one that proffers, or relates to proffering, a product (e.g., an application), a service, an incentive (e.g., a discount, coupon, or voucher), a property interest (e.g., real, intellectual, or virtual property), and the like. As used herein, an advertisement will be understood to include an offer. Additionally, as used herein, an in-application offer will be understood to include any offer presented within an application (e.g., over an application user interface associated with the application). An offer may proffer something on a trial basis, for demonstration purposes, for a cost (e.g., for purchase or rental), or for free, for example. Additionally, the item offered may be virtual or real in nature (e.g., a virtual or real good). Examples of goods can include software applications (also referred to herein as electronic applications), physical products (e.g., those available in a brick-and-mortar store), digital media (e.g., music, movie, books, etc.), and the like. Services can include professional services (e.g., legal or medical) and non-professional services. An offer may involve digital or real world delivery of an item being offered. In some instances, the offer can be similar to one commonly presented through web-based advertisements, such as trial versions of video games and other applications.

As used herein, a user interface will be understood to include a graphical user interface (GUI), which may be optimized for use on a touch-enabled display.

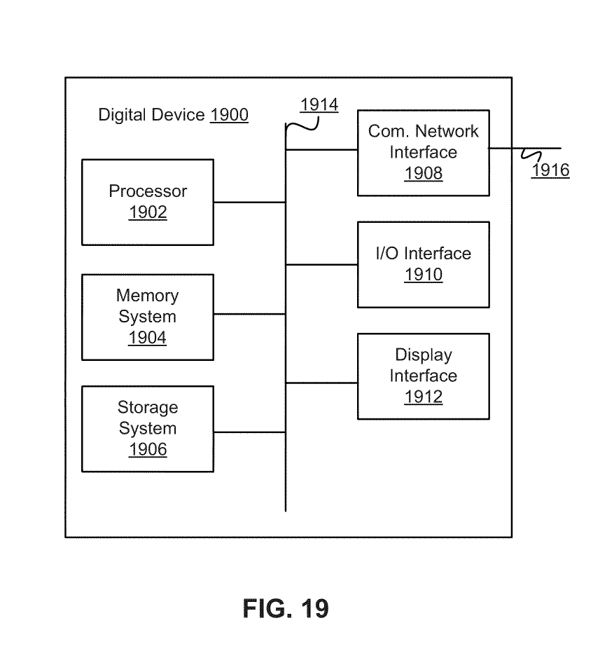

In accordance with some embodiments, a system or method can execute a first application (e.g., a video game) at a client computing device (e.g., mobile device), where the first application has an application user interface displayed on a screen (e.g., touch-enabled display) coupled to the computing device. The computing device may be a digital device. A digital device is any device with a processor and memory. One example of a digital device is shown in FIG. 19. A mobile device may also be a digital device.

The system or method can request offer(s) from an offer system and receive, in response, a set of offers from the offer system. The set of offers can include a first offer having a first graphical asset associated with the first offer (e.g., the first graphical asset is intended to visually represent the first offer). Depending on the embodiment, a graphical asset can include an image, an animation, a video, and/or other visual presentation. For instance, the first graphical asset may be an animated icon, which may be in-play when presented through various embodiments. The system or method can display the first graphical asset in a first moving graphical container, where the first moving graphical container is displayed in moving over (e.g., across, as if floating) the application interface. The system or method can further receive a particular user input with respect to the first moving graphical container, and cause the first moving graphical container to provide a first interactive response in response to the particular user input. The system or method can also perform an action with respect to the first offer in response to the particular user input (e.g., open, close, or ignore the first offer). An event with respect to an offer can include opening an offer (e.g., access details regarding the offer), closing the offer after it has been opened, an offeree declining the offer, the offeree accepting the offer, and the like.

The system or method may provide (e.g., grant) a reward based on the action performed with respect to the first offer or providing the reward based on the event with respect to the first offer. For example, a reward may be granted in response to a user opening the offer, accepting the offer, or successfully redeeming the offer (e.g., started and finished downloading application offered). The conditions upon which the reward is provided may vary between different embodiments. A reward can comprise any form of incentive, such as a coupon, a voucher, a gift certificate, or a credit. The incentive may be one redeemable by a recipient in the real world (e.g., in a physical retail store or through an online merchant) or in a virtual world (e.g., online virtual world). Additionally, the incentive may be one that can be redeemed with respect to the application through which the offer was originally accepted. When a reward is granted, it may be delivered electronically (e.g., electronic message, such as e-mail) or by physical delivery service (e.g., courier or postal service).

The system or method can further provide telemetry information regarding display of the first offer in the first moving graphical container, or regarding the particular user input received with respect to the first moving graphical containers. In some embodiments, such information can be useful in performing analytics with respect to user interaction with offers and user conversion through offers.

In accordance with some embodiments, a system or method can receive, at an in-application offer system, a request, from a client computing device, for one or more offers. The request may comprise client information regarding the client computing device. The system or method can select a set of offers based on the client information, and provide the client computing device with the set of offers to in response to the request. The system or method can receive from the client computing device telemetry information regarding at least one offer in the set of offers. Next, the system or method may detect detecting an event (e.g., successful conversion of the offer) with respect to the at least one offer in the set of offers, and may further grant a reward based the event.

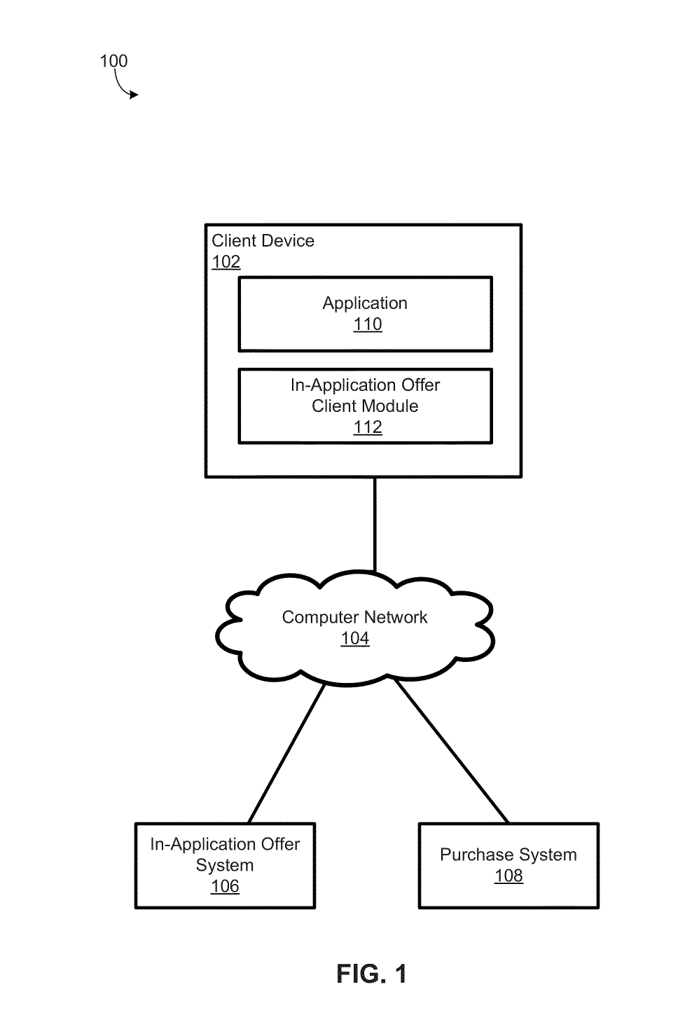

FIG. 1 is a block diagram illustrating an example environment 100 utilizing an in-application offer system in accordance with various embodiments. As shown in FIG. 1, the example environment 100 can comprise a client device 102, an in-application offer system 106, a purchase system 108, and a computer network 104 communicatively coupling together each of the client device 102, the in-application offer system 106, and the purchase system 108. It will be understood that for some embodiments, the components or the arrangement of components may differ from what is depicted in FIG. 1. In accordance with some embodiments, the computer network 104 may be implemented or facilitated using one or more local or wide-area communications networks, such as the Internet, WiFi networks, WiMax networks, private networks, public networks, and the like. Depending on the embodiment, some or all of the communication connections with the computer network 104 may utilize encryption (e.g., Secure Sockets Layer [SSL]) to secure information being transferred between the various entities shown in the example environment 100.

Each of the client device 102, the in-application offer system 106, and the purchase system 108 may be implemented using one or more digital devices, which may be similar to the digital devices discussed later with respect to FIG. 19. For example, the client device 102 may be any form of computing device capable of executing an application, presenting an application user interface through a display coupled to the computing device, presenting an in-application offer user interface through the display coupled to the computing device, and communicating with various entities in the example environment 100 through the computer network 104. For instance, through the computer network 104, the client device 102 can receive one or more offers from the in-application offer system 106, and can accept offers facilitated by way of the purchase system 108. The application user interface may facilitate interaction between a user of the computing device and an application executing on the computing device. The in-application offer user interface may facilitate interaction between a user of the computing device and one or more in-application offers presented through the computing device.

Computing devices may include a mobile phone, a tablet computing device, a laptop, a desktop computer, personal digital assistant, a portable gaming unit, a wired gaming unit, a thin client, a set-top box, a portable multi-media player, or any other type of network accessible user device known to those of skill in the art. Further, one or more of the in-application offer system and the purchase system 108 may comprise of one or more servers, which may be operating on or implemented using one or more cloud-based services (e.g., System-as-a-Service [SaaS], Platform-as-a-Service [PaaS], or Infrastructure-as-a-Service [IaaS]).

The client device 102 may be coupled to a computing device through which a user can be presented with one or more offers within an application (i.e., in-application offers) executing at the client device 102. For example, the client device 102 may be coupled to a display, such as a touch-enabled display, through which offers can be presented in moving graphical containers configured to receive user interaction (e.g., through the touch-enabled display). The client device 102 may be configured to await, and eventually receive, a user interaction with respect to the move graphical container. In response to receiving a user interaction, the client device 102 can perform a number of different actions including, for example, navigating to a page (e.g., web page or a page associated with an electronic application store) that includes the offer. Through an in-application offer user interface, the client device 102 may present offers over an application user interface of an application executing on the client device.

The client device 102 may be configured to communicatively connect with the in-application offer system 106, which can provide the client device 102 with one or more offers to for presentation over an application user interface at the client device 102. The client device 102 may also be configured to communicatively connect with the purchase system 108, which can facilitate redemption of the one or more offers presented at the client device 102, including offers provided by the in-application offer system 106.

As shown in FIG. 1, the client device 102 comprises an application 110, and an in-application offer client module 112. The application 110 may represent an application executing on the client device 102 and configured to present a user with an application user interface through a display coupled to the client device 102. The client device 102 may utilize an offer user interface configured to present offers in moving graphical containers, over the application user interface of the application 110. In accordance with some embodiments, the client device 102 may suspend the application 110 when a user opens an offer (e.g., navigates to a page providing offer details), the client device 102 may suspend the application 110 until such time as the offer is closed (e.g., offer has been accepted, redeemed, or declined).

The in-application offer client module 112 may be configured to facilitate in-application offers at the client device 102. For example, the in-application offer client module 112 may retrieve offers (e.g., from the in-application offer system 106) for presentation at the client device 102, manage presentation of offers through an in-application offer user interface, provide the in-application offer user interface over an application executing at the client device 102 (e.g., the application 110), and perform actions with respect to the offers presented through the in-application offer user interface. The in-application offer client module 112 may further control applications executing on the client device 102, and may further provide telemetry data regarding performance of the in-application offer client module 112. In some embodiments, the telemetry data provided by the in-application offer client module 112 may enable the performance of analytics on various activities facilitated by the in-application offer client module 112.

The in-application offer client module 112 may retrieve the offers as offer data (e.g., advertisement data), which may include links to pages for the offers and graphical assets (e.g., advertisement assets) intended to visually represent the offer at the client device 102. The in-application offer client module 112 may provide the client device 102 with an in-application offer user interface through which offers are presented on the client device 102 in moving graphical containers that are moving across the application user interface of the application 110. The in-application offer client module 112 may enable users to interact moving graphical containers presented on the client device 102, and respond to such interactions with respect the in-application offer, the moving graphical container, or both. In this way, the in-application offer client module 112 can permit redemption of offers presented through the client device 102. Depending on the embodiment, some or all of the in-application offer client module 112 may be implemented at the client device 102 through a software development kit (SDK), which can be embedded or utilized by the application 110 during operation.

The in-application offer system 106 may be configured to provide offers to be presented as in-application offers. For example, the in-application offer system 106 may provide the client device 102 with offers by receiving a request for an offer from the client device 102, selecting a set of offers based on the request, and then providing the client device 102 with the set of offers selected. The request may include information regarding the client device 102, such as the information regarding device type, hardware, operating system, installed software, or the user at the client device 102. Additionally, when providing the offer to the client device 102, the in-application offer system 106 may provide to the client device 102 offer data that may include offer details, a graphical asset, a link to a page regarding the offer, and the like. The in-application offer system 106 may also provide the client device 102 with configuration data that specifies aspects regarding presentation of the offer at the client device 102. The configuration data may, for instance, define specifics regarding offers to be presented at the client device 102 (e.g., which ones, how many, how often, etc.) and the moving graphical container used to present the offers (e.g., type, size, behavior, permitted/restricted user interactions, type of movement, speed of movement, entry to/exit from display, etc.).

Based on telemetry data received from the client device 102, the in-application offer system 106 may perform analytics regarding in-application offers presented at the client device 102. For example, the in-application offer system 106 may utilize the telemetry data from the client device 102 to track conversion facilitated through in-application offers presented at the client device 102. The in-application offer system 106 may also use telemetry data received from the client device 102 to measure user interaction and engagement with the in-application offer user interface that presents in-application offers to the user at the client device 102.

The purchase system 108 may be configured to facilitate conversion of an offer, such as an in-application offer. For example, the purchase system 108 may assist in the operation of a website (e.g., e-commerce website) or an online store (e.g., application store) in connection with an in-application offer presented at the client device 102. Access to operations and services provided by the purchase system 108 may be facilitated at the client device through an application internal or external to the application with which the in-application offers are being presented. For example, in order to access a web page hosted by the purchase system 108 in connection with an in-application offer presented over the application user interface of the application 110, a web browser external to the application 110 may be launched and directed to the web page by the in-application offer client module 112.

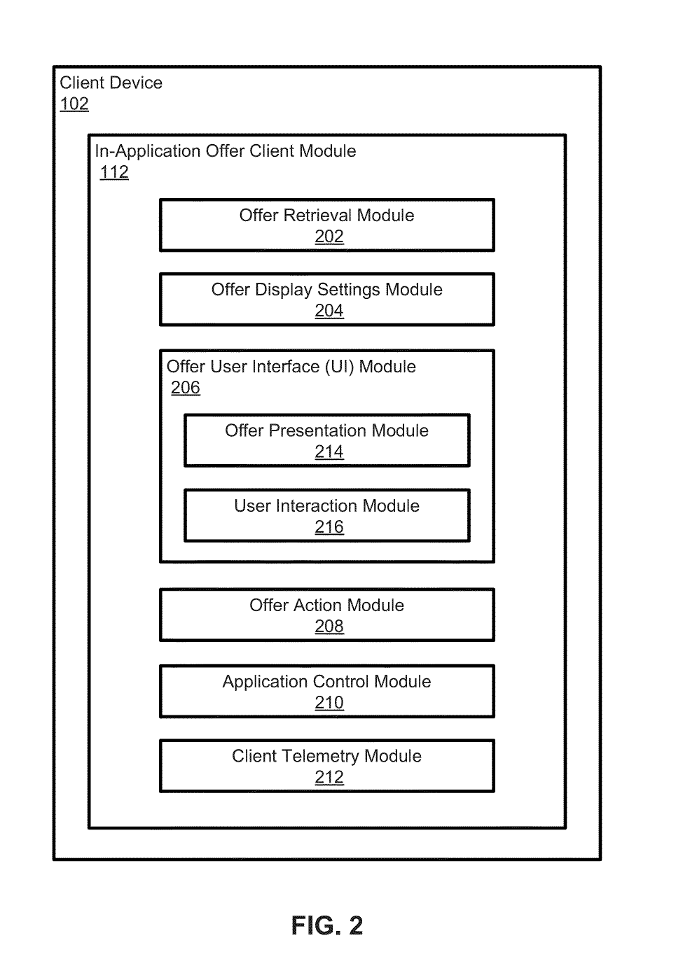

FIG. 2 is a block diagram illustrating the in-application offer client module 112 in accordance with various embodiments. The in-application offer client module 112 of the client device 102 may comprise an offer retrieval module 202, an offer display settings modules 204, an offer user interface (UI) module 206, an offer action module 208, an application control module 210, and a client telemetry module 212. It will be understood that for some embodiments, the components or the arrangement of components may differ from what is depicted in FIG. 2.

The offer retrieval module 202 may be configured to retrieve a set of offers to be presented at a client device as in-application offers. The offer retrieval module 202 may retrieve the offers from a local cache (e.g., offers previously acquired) or from an in-application offer system. For some embodiments, the offer retrieval module 202 may retrieve the set of offers by requesting one or more offers from an in-application offer system. Depending on the embodiment, the request may include information regarding the client device 102, such as the information regarding hardware, operating system, installed software, or the user at the client device 102. For some embodiments, the information included with the request may enable the in-application offer system to select the set of offers to be provided to the client device 102.

The offer display settings modules 204 may be configured to manage settings for displaying in-application offers on the client device 102. In some embodiments, the offer display settings modules 204 may manage the display settings by permitting a user at the client device 102 to define or adjust the display settings according to their preferences, by receiving such settings from an in-application offer system, or some combination of both. Where the offer display settings adjusted at a client device 102 conflict with display settings provided by an in-application offer system, various embodiments may resolve the conflict by overriding one of the settings over the other (e.g., display settings from the in-application offer system override display settings at the client device 102) or by prompting the user at the client device 102 regarding the conflict and asking them to resolve it.

The offer user interface module 206 may be configured to facilitate interaction between a user at the client device 102 and the in-application offer client module 112. For example, the offer user interface module 206 may be configured to present an in-application offer user interface over an application user interface being presented by an application executing at the client device 102. For some embodiments, the in-application offer client module 112 may use an in-application user interface to present in-application offers in moving graphical containers, which may be configured to receive and respond to user interaction from a user at the client device 102.

As shown in FIG. 2, the offer user interface module 206 may comprise an offer presentation module 214, and a user interaction module 216. The offer user interface module 206 may be configured to provide an in-application offer user interface over an application user interface of an application executing at the client device 102. The offer presentation module 214 may display one or more offers in moving graphical containers over the application user interface of the application. The user interaction module 216 may be configured to receive user interactions (or indications thereof) with respect to the in-application offer user interface provided by the offer user interface module 206, including those received with respect to moving graphical containers. In response to the user interactions to the in-application offer user interface, the user interaction module 216 may cause an action with respect to a moving graphical container, an in-application offer being represented by a graphical asset in a moving graphical container, or both. For example, the user interaction module 216 may respond performing an action with respect to the in-application offer being represented by a graphical asset in the moving graphical container (e.g., navigate to a page relating to the offer), by displaying a graphical response (e.g., an animation) with respect to the graphical container, or by displaying a graphical response (e.g., an animation) with respect to the graphical asset of the in-application offer.

The offer action module 208 may be configured to may be configured to perform an action with respect to an in-application offer being represented by a graphical asset in a moving graphical container. An action with respect to the in-application offer may comprise opening, closing, accepting, declining, or accessing details regarding the in-application offer. In some embodiments, opening the in-application offer may comprise navigating to a page (e.g., of a website or an application store) regarding the in-application offer.

The application control module 210 may be configured to control operational status of an application presenting an application user interface over which an in-application offer is being presented by the offer user interface module 206. For some embodiments, when user interaction with an in-application offer causes the client device to navigate away from the application or the application user interface (e.g., when navigating to page outside the application), the application control module 210 may cause the application to be suspended. For instance, where a user at the mobile device 612 begins to interact with the in-application offer user interface presented by the offer user interface module 206 (e.g., interacting with the moving graphical containers presented by the in-application offer user interface), the application control module 210 may temporarily suspend the application. In some embodiments, the application control module 210 may cause the application to remain suspended until such time as the user at the client device 102 ceases to interact with the in-application offer user interface presented by the offer user interface module 206, or the user returns from being navigated away from the application.

The client telemetry module 212 may be configured to provide external systems with telemetry information regarding performance of the in-application offer client module 112. For some embodiments, the client telemetry module 212 may provide the telemetry data to the in-application off system that provided the client device 102 with offers, or provide the telemetry data to a third-party analytics system. In some embodiments, the telemetry data provided by the client telemetry module 212 may permit performance of analytics (e.g., the measurement of performance and effectiveness) with respect to the in-application offer client module 112 and the in-application offers it presents. In some embodiments, telemetry data provided by the client telemetry module 212 may relate to user interactions performed with respect to moving graphical containers used to present the in-application offers (e.g., in order to analyze level of user engagement). The telemetry data may permit tracking of conversion rates for in-application offers presented through the offer user interface module 206 (e.g., ‘click-to-conversion’ information).

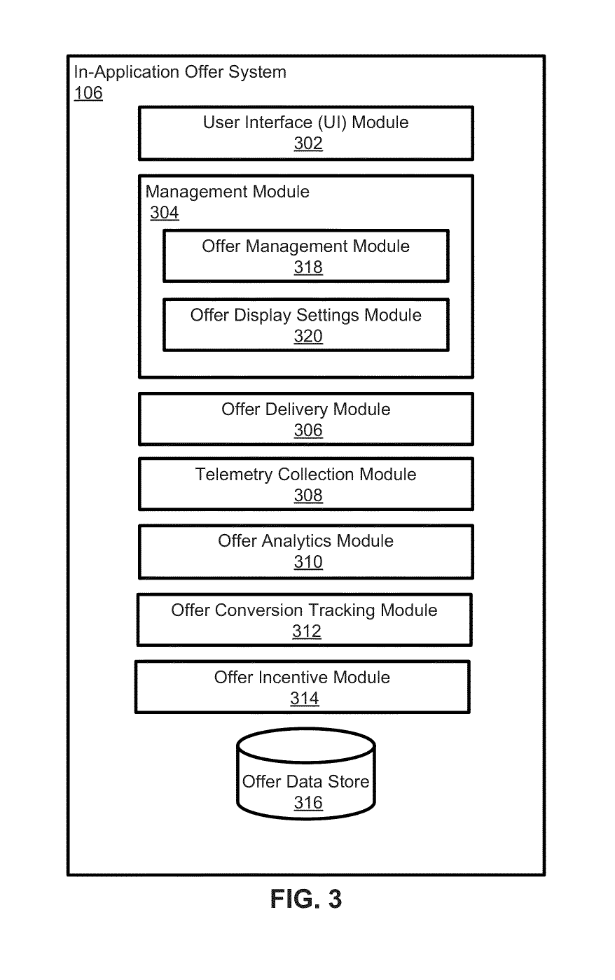

FIG. 3 is a block diagram illustrating the in-application offer system 106 in accordance with various embodiments. As shown in FIG. 3, the in-application offer system 106 can comprise a user interface (UI) module 302, a management module 304, an offer delivery module 306, a telemetry collection module 308, an offer analytics module 310, an offer conversion tracking module 312, an offer incentive module 314, and an offer data store 318.

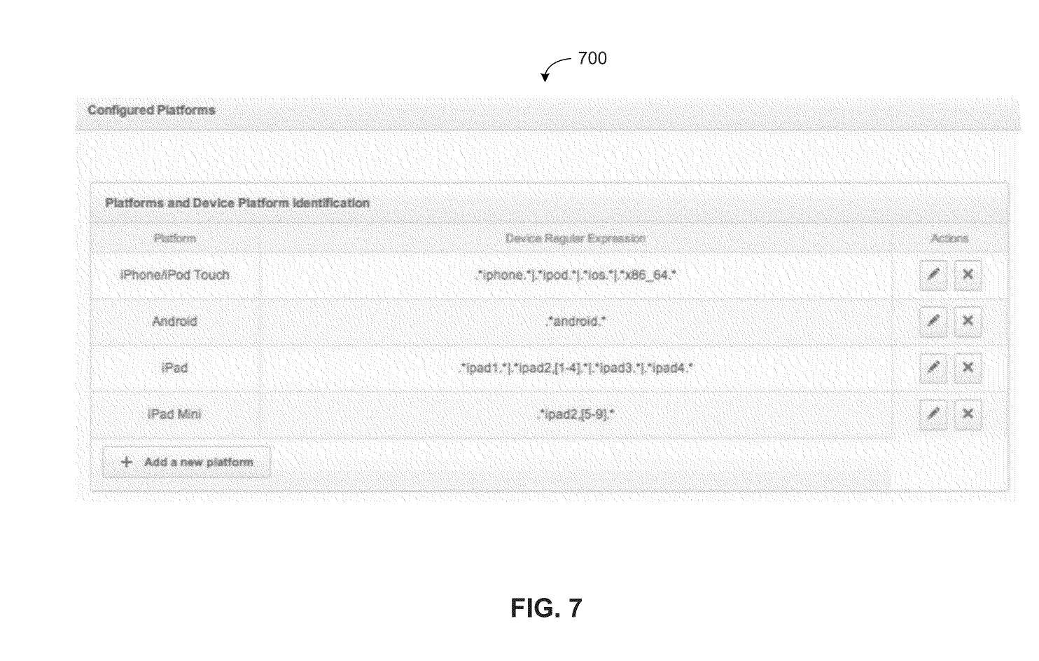

The user interface module 302 may be configured to provide a user interface through which a user, such as an administrator of an in-application offer system, an offerer (e.g., advertiser), an offer (e.g., advertisement) account manager, can interact and manage the in-application offer system 106. In accordance with some embodiments, the user interface module 302 may facilitate use access to a configuration dashboard that allows a user to review or control various operational aspects of the in-application offer system 106. For example, the configuration dashboard may comprise various panels that facilitate the addition, deletion, or modification of configuration options with respect to offers that the in-application offer system 106 provides a client device for presentation as in-application offers. Depending on the embodiment, the configuration dashboard may be accessible over a network and may comprise a web-enabled user interface. More regarding panels that may be presented by a configuration dashboard of the in-application offer system 106 are described herein with respect to FIGS. 7-14.

The management module 304 may be configured to various operations of the in-application offer system 106. For example, as described herein, a user and/or another application may interact and manage the in-application offer system 106 through configuration dashboard, which may be accessed by a user through the user interface module 302. As shown in FIG. 3, the management module 304 may comprise an offer management module 318, and an offer display settings module 320. The offer management module 318 may be configured to manage one or more offers that can be provided, by the in-application offer system 106, to a client device for presentation as in-application offers. For example, through the offer management module 318, a user may add, delete, modify, enable, or disable an offer that may be provided to a client device for presentation as in-application offers. Management of the offers on the in-application offer system 106 may include configuration of properties (e.g., application store identifiers), options (e.g., presentation options for moving graphical containers), and restrictions (e.g., territory, client applications, or device platforms) with respect to the offers available on the in-application offer system 106. The offer management module 318 may also enable a user to review and edit global settings with respect to offers provided by the in-application offer system 106, including settings that determine what types of client devices will receive offers and what applications on client devices will receive offers.

In various embodiments, the user may utilize the configuration dashboard to control physics of the moving graphical container(s). For example, the configuration dashboard may control the speed of movement, the interactivity with the surroundings of the screen or other graphical elements (e.g., the degree of spring when a moving graphical container “bounces” or whether the graphical element moves off screen and may return later). The configuration dashboard may also be used to define activities upon configuration including, for example, changes to the moving graphical containers. For example, a moving graphical container that appears as a bubble may appear to pop, melt, disappear, or have other action including sounds or vibrations of the mobile device. A moving graphical container that appears as a snowflake may also be configured to appear to pop, melt, or the like upon interaction.

Those skilled in the art will appreciate that the management modules 304 may be configured or receive configurations remotely. For example, a server on a network may communicate with multiple management modules 304 and provide the same or different configurations to any one or set within the multiple management modules 304.

The offer display settings module 320 may be configured to manage settings relating to the presentation of offers provided by the in-application offer system 106 and presented at a client device as in-application offers. Through the offer display settings module 320, a user may at the in-application offer system 106 may override display settings manage or defined locally by a user at a client device. The display settings managed or defined through the offer display settings module 320 may determine such settings as the number, size, type (e.g., bubble or snowflake), point of entry on the display (e.g., corner, bottom, or top), and point of exit of moving graphical containers presented at a client device.

More regarding management of configurations and settings of an in-application offer system is discussed herein with respect to FIGS. 7-14.

The offer delivery module 306 may be configured to provide a client device with a set of offers for presentation at the client device as in-application offers. In accordance with some embodiments, providing the client device with offers may comprise receiving from the client device a request for an offer, selecting a set of offers based on the request, and providing the set of offers to the client device. In some embodiments, the offers may be provided to the client device as offer data (e.g., advertisement data), which may include details, a graphical asset, and a link to a page in connection with each offer in the set of offers. Selecting the set of offers based on the request may comprise client device information included in the request

As described herein, a request from a client device for an offer may include information regarding the requesting client device, such information including device type, hardware, operating system, installed software, and the user at the client device. Based on the configurations, options, or restrictions associated with offers available at the in-application offer system 106, the offer delivery module 306 may match the information regarding the client device with a set of appropriate offers.

The telemetry collection module 308 may be configured to collect telemetry data provided by a client device that requests an offer from the in-application offer system 106. As described herein, the telemetry information may be regarding performance of in-application offers at a client device. For some embodiments, the telemetry collection module 308 may receive telemetry data that permits performance of analytics (e.g., the measurement of performance and effectiveness) with respect to in-application offers at the client device. In some embodiments, the telemetry data received may relate to user interactions performed with respect to moving graphical containers used to present in-application offers at the client device. The telemetry data may also permit tracking of conversion rates for in-application offers presented at the client device (e.g., ‘click-to-conversion’ information).

The offer analytics module 310 may be configured to perform analytics regarding in-application offers presented at a client device. In accordance with some embodiments, the offer analytics module 310 may utilize telemetry data received through the telemetry collection module 308 to perform the analytics.

The offer conversion tracking module 312 may be configured to determine conversion achieved through in-application offers presented at a client device. For some embodiments, the offer conversion tracking module 312 may use the telemetry data received through the telemetry collection module 308 to identify conversion events with respect to in-application offers presented and access at a client device. In some embodiments, the offer conversion tracking module 312 may use telemetry data to match store purchase events (e.g., purchase event at a third-party application store, such as Apple® App Store) facilitated through an in-application offer presented at the client device, with the launch event of an application store at the client device through the in-application presented at the client device.

The offer incentive module 314 may be configured to grant an incentive to a user based on an event that has occurred with respect to an in-application offer presented at a client device. For example, accessing the in-application offer may be incentivized for a user by granting a reward to the user for causing a particular event with respect to the in-application offer. The user may, for example open, accept, or redeem the in-application offer, and such an event may result in the user being granted an incentive. Examples of incentives can include a discount, coupon, voucher, a reward, credit, currency, and the like. The incentives may be real or virtual. Depending on the embodiment, the incentive granted may be tied to the application from which the in-application offer was accessed (e.g., opened). For instance, where the in-application offer was accessed through a video game, the incentive for redeeming the in-application offer and causing a successful conversion may result in the offer incentive module 314 rewarding the user with a virtual object or credit in the video game.

The offer data store 316 may be configured to store and retrieve data in connection with various operations performed by the in-application offer system 106 and its various components. For example, the offer data store 316 may be configured to manage storage of offers available for service to client devices as in-application offers. The offer data store 316 may store details, properties, configuration options, or graphical assets associated with a given offer. Further, the offer data store 316 may store telemetry data, provided by a client device, regarding performance of in-application offers at the client device. For some embodiments, some or all of the offer data store 316 may be implemented by way of a database system.

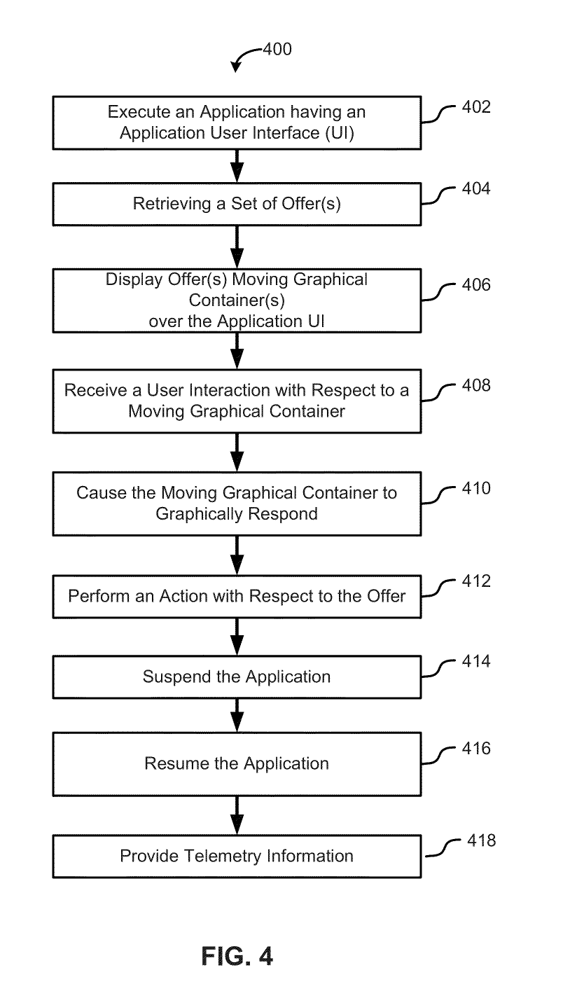

FIG. 4 is a flowchart illustrating an example method 400 for providing an in-application offer in accordance with various embodiments. As described below, for some embodiments, the method 400 may perform operations in connection the client device 102 and, more particularly, the in-application offer client module 112.

The method 400 may start at operation 402, with a client device 102 executing, at the client device 102, an application having an application user interface. In accordance with various embodiments, the application executed at the client device 102 may be a variety of applications, including a video game.

At operation 404, the offer retrieval module 202 may retrieve a set of offers for presentation at the client device 102 as in-application offers. In some embodiments, retrieval of the offer may comprise the requesting one or more offers from an in-application offer system. In certain embodiments, the request may include information regarding the client device 102, such as the information regarding hardware, operating system, installed software, or the user at the client device 102. For some embodiments, the information included with the request may enable the in-application offer system to select the set of offers to be provided to the client device 102.

At operation 406, the offer presentation module 214 may display one or more offers in moving graphical containers over the application user interface of the application executed at operation 402. When displaying a given offer, the offer presentation module 214 may display one or more graphical assets associated with that given offer in a moving graphical container, such as a bubble or a snowflake. As described herein, the offer presentation module 214 may display the offers using an in-application offer user interface provided by the offer user interface module 206.

At operation 408, the user interaction module 216 may receive a user interaction with respect to at least one of the moving graphical containers displayed over the application user interface. A valid user interaction may comprise one or more user inputs received at the client device 102 through a user input device coupled to the client device 102.

As described herein, user interactions received with respect to a graphical container may cause the user interaction module 216 to respond with respect the in-application offer (e.g., open the in-application offer), the moving graphical container (e.g., provide a graphical response), or both. Accordingly, at operation 410, the user interaction module 216 may cause the moving graphical container to graphically respond based on the user interaction received. For example, where a user has dragged-and-dropped a moving graphical container, the user interaction module 216 may cause the moving graphical container to be displaced from one portion of a display of the client device 102 to another portion of the display of the client device 102, according to the drag-and-drop action. In another example, where the user interaction comprises a tap to a touch-enabled screen, the user interaction module 216 may cause the moving graphically container to disappear (e.g., where the moving graphically container is a snowflake, it would melt).

At operation 412, the user interaction module 216 may cause a response with respect to an in-application offer presented in a moving graphical container that received user interaction. For instance, the user interaction module 216 may cause a graphical asset representing the in-application offer in the moving graphical container to change (e.g., from one image to another image). In another example, the user interaction module 216 may cause the in-application offer to open at the client device by navigating to a page associated with the in-application offer (e.g., page on a website or in an online store).

At operation 414, the application control module 210 may suspend an application in which an in-application offer was presented and accessed. For example, where the in-application offer is presented at the beginning of a video game (e.g., menu page) or between different levels, accessing the in-application may cause the client device 102 to navigate away from the video game (or its game user interface) in order review a page relating to the in-application offer (e.g., in at website or in an application store). In the meantime, the application control module 210 may utilize multi-tasking features of the client device 102 to suspend the video game while the user is away from the game user interface. At operation 416, the application control module 210 may resume the application once the user has concluded with the in-application offer (e.g., accepted, redeemed, or declined the in-application offer).

At operation 418, the client telemetry module 212 may provide external systems with telemetry information regarding performance of in-application offers at the client device 102. For some embodiments, the client telemetry module 212 may provide the telemetry data to an in-application off system that is providing the client device 102 with offers, or provide it to a third-party analytics system.

Though the operations of the above method may be depicted and described in a certain order, those skilled in the art will appreciate that the order in which the operations are performed may vary between embodiments, including performing certain operations in parallel. Additionally, those skilled in the art will appreciate that the components described above with respect to the method 400 of the flowchart are merely examples of components that may be used with the method, and for some embodiments other components may also be utilized in some embodiments.

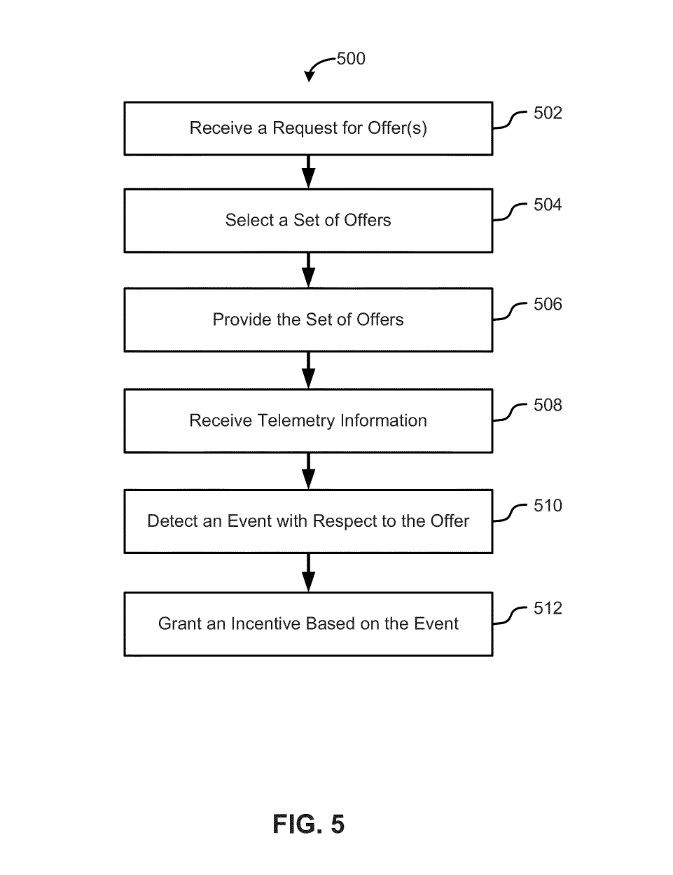

FIG. 5 is a flowchart illustrating an example method 500 for providing an in-application offer in accordance with various embodiments. As described below, for some embodiments, the method 500 may perform operations in connection the in-application offer system 106.

The method 500 may start at operation 502, with the offer delivery module 306 receiving a request for an offer from a client device. As described herein, a request from a client device for an offer may include information regarding the requesting client device.

At operation 504, the offer delivery module 306 may select a set of offers based on the request received at operation 502. According to some embodiments, selecting the set of offers based on the request may comprise client device information included in the request. Based on the configurations, options, or restrictions associated with offers available at the in-application offer system 106, the offer delivery module 306 may match the information regarding the client device with a set of appropriate offers.

In various embodiments, any number of the offers of the set may be based on user information. For example, the request may comprise user information that identifies the user, the telemetry associated with the user, or the like. Other user information that may be utilized may include demographic information, past interactions with advertisements, purchase information, mobile device use, and/or any other information. In some embodiments, the offer delivery module 306 may identify the user with information from the request and then retrieve a profile associated with the user's past purchase history and/or interactions (e.g., with applications, advertisements, offers, web surfing, and/or the like). The offer delivery module 306 may select offers based on the user information from the request and/or the profile. For example, the offer delivery module 306 may select offers for Disney vacations if the user has interacted with similar vacation offers or offers associated with children.

At operation 506, the offer delivery module 306 may provide the set of offers to a client device requesting an offer from the in-application offer system 106. In some embodiments, the offers may be provided to the client device as offer data (e.g., advertisement data), which may include details, a graphical asset, and a link to a page in connection with each offer in the set of offers.

At operation 508, the telemetry collection module 308 may receive telemetry data provided by a client device that requests an offer from the in-application offer system 106. As described herein, the telemetry information may be regarding performance of in-application offers at a client device. For some embodiments, the telemetry collection module 308 may receive telemetry data that permits performance of analytics (e.g., the measurement of performance and effectiveness) with respect to in-application offers at the client device. In some embodiments, the telemetry data received may relate to user interactions performed with respect to moving graphical containers used to present in-application offers at the client device. The telemetry data may also permit tracking of conversion rates for in-application offers presented at the client device (e.g., ‘click-to-conversion’ information). In some embodiments, telemetry collection module 308 may facilitate conversion of the telemetry data provided by the client device such the resulting converted telemetry data can be analyzed using a third-party analytics services, such as Hasoffers® and Flurry®.

At operation 510, the offer analytics module 310 or the offer conversion tracking module 312 may detect an event with respect to an offer presented at a client device as an in-application offer. For some embodiments, based on the telemetry data received at operation 508, the offer analytics module 310, the offer conversion tracking module 312, or both may detect an event with respect to an in-application offer presented at the client device. For example, the offer analytics module 310 may analyze user interactions received with respect to the in-application offer at the client device, and may determine from that analysis that a user at the client device caused the in-application offer to be opened, accepted, or declined. As described herein, events with respect to an offer can include opening, accepting, declining, and redeeming the offer. In another example, the offer conversion tracking module 312 may analyze the telemetry data and determine whether the in-application offer resulted in a successful conversion event (e.g., purchase of a product from an application store).

At operation 512, the offer incentive module 314 may grant an incentive with respect to an in-application offer based on an event detected with respect to the in-application offer. In some embodiments, the offer incentive module 314 may grant the incentive based on the event detected by the offer analytics module 310 or the offer conversion tracking module 312 at operation 510.

Though the operations of the above method may be depicted and described in a certain order, those skilled in the art will appreciate that the order in which the operations are performed may vary between embodiments, including performing certain operations in parallel. Additionally, those skilled in the art will appreciate that the components described above with respect to the method 500 of the flowchart are merely examples of components that may be used with the method, and for some embodiments other components may also be utilized in some embodiments.

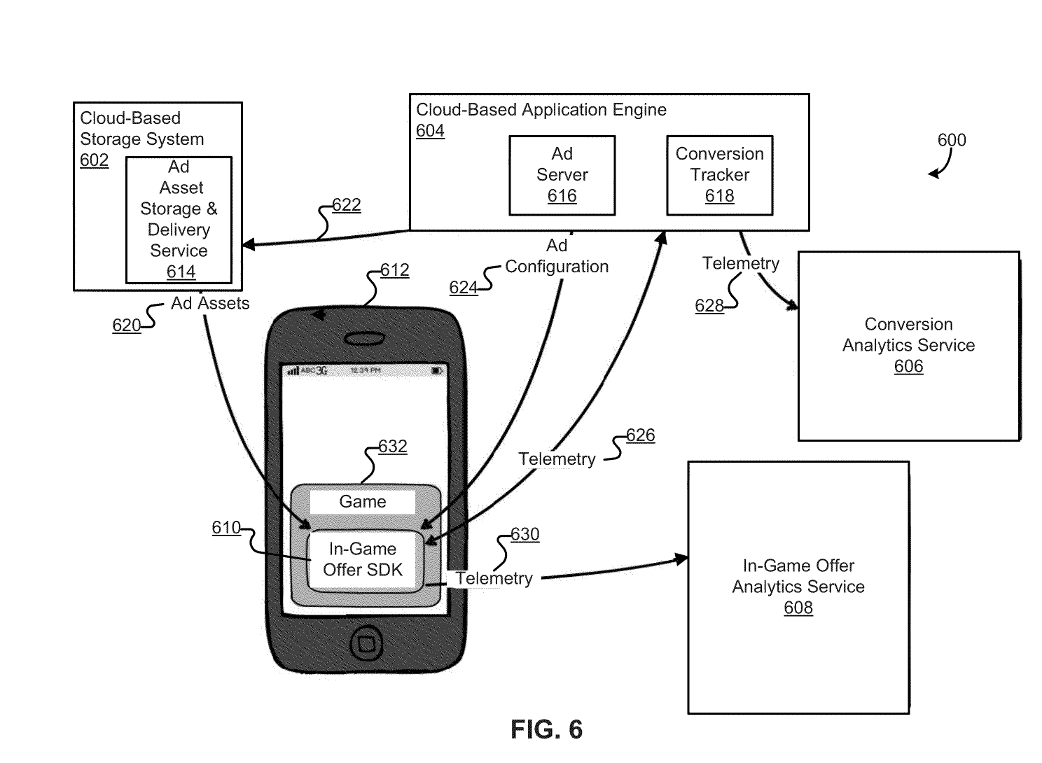

FIG. 6 is a block diagram illustrating an example system 600 for providing an in-application offer in accordance with various embodiments. As shown in FIG. 6, the system 600 may comprise a cloud-based storage system 602, a cloud-based application engine 604, a conversion analytics service 606, an in-game offer analytics service 608, and in-game offer SDK 610. As also shown in FIG. 6, the system 600 may operate in conjunction with a mobile device 612, which may be similar to the client device 102 described herein. It will be understood that for some embodiments, the composition or arrangement of the system 600 may vary between embodiments. For example, the system 600 may comprise less than all the components depicted in FIG. 6, may comprise only the client-side components depicted, may comprise only the server-side components depicted, or may exclude components provided or operated by third-parties. Additionally, for some embodiments, the various components of the system 600 may be implemented by the embodiments described herein, particularly with respect to FIGS. 1-3.

The cloud-based application engine 604 may provide a computing platform utilizing cloud-based resources, such as virtualized computing hardware, to operate components of the system 600. In some embodiments, the cloud-based application engine 604 may be capable of operating components of the system 600 as applications (e.g., server application) executing in a cloud-based executable environment. Depending on the embodiment, the cloud-based application engine 604 may be one operated by the operator of the system 600, or may be one commercially provided by a third-party (e.g., Google® App Engine).

As shown in FIG. 6, the cloud-based application engine 604 may be used to operate an advertisement server 616 and a conversion tracker 618. In some embodiments, the advertisement server 616 may provide a configuration dashboard through which a user of the system 600 can manage in-application offers (e.g., in-game offers) to be presented at the mobile device 612 and configure options with respect to the in-application offers, such as targeting options for in-application offers and restrictions on presentation of in-application offers (e.g., restrictions based on client device type, device hardware, operating system, user demographics, etc.). The configuration dashboard may comprise one or more configuration panels that permit a user to configure operation of the system 600 through a graphical interface. More regarding panels that may be presented through the configuration dashboard are discussed herein with respect FIGS. 7-14. For some embodiments, the configuration dashboard provided by the advertisement server 616 may be through a web portal accessible by a user. The advertisement server 616 may also provide services, such as web services, that provide the mobile device 612 with data utilized in the presentation of offers at the mobile device 612. For example, the advertisement server 616 may cause an advertisement asset be sent to the mobile device 612 (e.g., request 622) or cause an advertisement configuration 624 to be sent to the mobile device 612. Depending on the embodiment, the advertisement asset may include an image, content for interstitial ads, a video, an animation, or the like, which may be presented at the mobile device 612 in connection with an in-application offer (e.g., in-game offer). In some embodiments, the advertisement configuration 624 may be configured to control how in-application offers (e.g., in-game offers) are presented, behave, or receive user interact at the mobile device 612. In some embodiments, the advertisement server 616 may provide links to the offer represented by the advertisement assets 620, where the link may navigate the mobile device 612 to a page including the offer (e.g., details regarding the offer).

The cloud-based storage system 602 may provide a data storage platform that utilizes cloud-based resources, such as virtualized computer systems and hardware, to provide data storage services for various components of the system 600. Depending on the embodiment, the cloud-based application engine 604 may be one managed and operated by the operator of the system 600, or may be one commercially provided by a third-party (e.g., Amazon® S3).

As shown in FIG. 6, the cloud-based storage system 602 may be used to operate an advertisement asset storage and delivery service 614. The advertisement asset storage and delivery service 614 may be configured and utilized to provide (e.g., delivery) advertisement assets to client devices, where such advertisement assets will be presented in connection with in-application offers (e.g., in-game offers). Accordingly, the advertisement asset storage and delivery service 614 may provide the mobile device 612 with advertisement assets 620, and may do so based on the request 622 sent by the advertisement server 616.

As shown in FIG. 6, the mobile device 612 may be capable of executing a game 632 that includes an in-game offer SDK 610. The game 632 may be one configured to operate on the mobile device 612, and may be one available through a mobile application store associated with the mobile device 612. It will be appreciated that for some embodiments, a non-game application may take the place of the game 632 and utilize an SDK similar to the in-game offer SDK 610.

In accordance with some embodiments, the in-game offer SDK 610 may be configured to be embedded in or interfaced by the game 632. Depending on the embodiment, the game 632 may be developed to interact with the in-game offer SDK 610 through application program interfaces (APIs) and integration layers utilized by the game 632. The in-game offer SDK 610 may be configured retrieve offer data from the advertisement server 616, where retrieving the offer data may comprise receiving the advertisement assets 620 and the advertisement configuration 624 to control presentation of the advertisement assets 620 in the game 632 (e.g., over the game user interface). The advertisement server 616 may provide the mobile device 612 with offer data at the request of the in-game offer SDK 610. Such a request may provide specifics regarding the offers the mobile device 612 is requested including, for example, the types of offers, or the number of offers that the mobile device 612 expects to receive. The request may include information regarding the mobile device 612 or the user at the mobile device 612, which may be utilized in determining what offers provided by the advertisement server 616.

In accordance the embodiments described herein, the in-game offer SDK 610 may present the advertisement assets 620 in moving graphical containers that move across the game user interface of the game 632. As also described herein, the moving graphical containers utilized may include those that may be considered fun or engaging to the user of the mobile device 612, such bubbles or snowflakes. As the mobile device 612 receives user interactions with respect to the moving graphical containers, the in-game offer SDK 610 may cause the moving graphical containers to graphically respond (e.g., bubble pops or can be pushed, or snowflake can melt), or cause an action with respect to the offers presented in the moving graphical containers. For instances, the in-game offer SDK 610 may cause the mobile device 612 to respond to the user interactions by navigating to a page including the offer (e.g., details regarding the offer). The navigation may be according to a link provided to the mobile device 612 by the advertisement server 616 or the advertisement asset storage and delivery service 614. As described herein, navigating to the page may include navigating to a website including the page, or navigating to a store configured to facilitate redemption of the offer presented. The store can include one configured to facilitate purchase of various products or services, including digital products such as an application or digital media (e.g., music, video, or books). For example, navigating to the page may comprise navigating to a page associated with an electronic application store and the offer is associated with one or more applications.

For some embodiments, when the in-game offer SDK 610 causes the mobile device to navigate away from the game 632 or the game user interface related thereto (e.g., when navigating to page outside the game 632), the in-game offer SDK 610 may cause the game 632 to be suspended. For example, where a user at the mobile device 612 begins to interact with the offer user interface presented by the in-game offer SDK 610 (e.g., interacting with the moving graphical containers presented by the offer user interface), the in-game offer SDK 610 may temporarily suspend the game 632. In another example, where the user at the mobile device 612 is directed away from the game 632 and to a page regarding an offer (e.g., presented through a web browser or an application store, which may be external to the game 632), the in-game offer SDK 610 may temporarily suspend the game 632 or its associated game user interface.

In some embodiments, the in-game offer SDK 610 may cause the game 630 to remain suspended until such time as the user at the mobile device 612 ceases to interact with the offer user interface presented by the in-game offer SDK 610 (e.g., the user closes a related window), or the user returns from being directed away from the game 632. For example, where the user at the mobile device 612 is directed to a page in an application store associated with the mobile device 612, the in-game offer SDK 610 may not resume the game 632 until the application store is closed (e.g., successful conversion or declination of the offer) and the user is returned to the game 632. After navigation away from the game 632, the in-game offer SDK 610 may facilitate the return of the user to the game 632.

Where navigation away from the game 632 necessitates the launch of an application external to the game 632 (e.g., external web browser or application store), the in-game offer SDK 610 may facilitate the launch (and possible subsequent termination) of the application. Where the external application to be launched is already running, the in-game offer SDK 610 may transition from the game 632 over the already running application, and may transition back to the game 632 when use of the external application has concluded (e.g., use has concluded with respect to the offer that caused the transition to the external application). The in-game offer SDK 610 may perform such launch and switch functions by utilizing the multi-tasking available on the mobile device 612.

In some embodiments, the in-game offer SDK 610 may, in response to user interactions, cause the mobile device 612 to different types of output, including audio (e.g., sound of a bubble popping or bouncing) or vibration (e.g., vibrate when bubbles are popped or bounce). Such output may be an alternative to, or in addition to, outputting a graphical response (e.g., with respect to the moving graphical container) to the user interactions.

In connection with receiving and presenting offers at the mobile device 612, the in-game offer SDK 610 may provide various components of the system 600 with telemetry information that permits performance of analytics (e.g., the measurement of performance and effectiveness) with respect to the in-game offer SDK 610 and the offers it presents. For example, telemetry data provided by the in-game offer SDK 610 may relate to user interactions performed with respect to moving graphical containers used to present the offers (e.g., in order to analyze level of user engagement). The telemetry data may permit tracking of conversion rates for offers presented through the in-game offer SDK 610 (e.g., ‘click-to-conversion’ information).

As shown in FIG. 6, based on presenting the advertisement assets 620 at the mobile device 612 (e.g., in accordance with the advertisement configuration 624), the in-game offer SDK 610 may provide the conversion tracker 618 with telemetry data 626. Using the telemetry data 626, the conversion tracker 618 may be configured to identify conversion through an offer presented at the mobile device 612 through the in-game offer SDK 610. For instance, the conversion tracker 618 may use the telemetry data 626 to match store purchase events (e.g., purchase event at a third-party application store, such as Apple® App Store) facilitated through an offer (e.g., in-game offer) presented at the mobile device 612, with the launch event of the application store at the mobile device 612 through the in-game offer SDK 610. Additionally, to facilitate additional analytics regarding conversion through offers presented by the in-game offer SDK 610, the conversion tracker 618 may be configured to provide some or all of the telemetry data 626 to the conversion analytics service 606 as telemetry data 628. The conversion analytics service 606 may be configured to measure, for example, how many offers lead to conversion after the offers were opened, how much money was generated by offers, demographics of users who were converted through the offers, the time between opening an offer and the conversion, and the like. Analytics regarding the in-game offer SDK 610 may be presented using graphs, charts, and tables, and may be presented to the operator of the system 600 (e.g., an administrator or an advertiser/offerer) through a web-based user interface. In some embodiments, the telemetry data 628 may be adapted by the conversion tracker 618 to be compatible with the conversion analytics service 606. In some embodiments, the conversion analytics service 606 may be implemented, in whole or in part, by a service provided by a third-party, such as Hasoffers® or Flurry®.

According to some embodiments, the in-game offer SDK 610 may directly provide an analytics services with telemetry data 630. For example, as shown in FIG. 6, the in-game offer SDK 610 may provide the telemetry data 630 to the in-game offer analytics service 608. The in-game offer analytics service 608 may be configured to perform analytics regarding performance and user interaction of the in-game offer SDK 610. For instance, the in-game offer analytics service 608 may configured to measure how many users interacted with the moving graphical containers, how many moving graphical containers/offers have been presented, how long users interact with the moving graphical containers, what types of moving graphical containers solicit more interactions, and the like. In some embodiments, the in-game offer analytics service 608 may be implemented, in whole or in part, by a service provided by a third-party, such as Google® Analytics.

Although the discussion regarding FIG. 6 discusses various embodiments and examples utilizing the mobile device 612, those skilled in the art will appreciate that any digital device, not just a device that is mobile, may be utilized. For example, a game console, personal computer, media player, laptop, or the like may perform various systems and methods described herein.

FIG. 7 is a screenshot illustrating an example panel 700 for managing options for application offers in accordance with various embodiments. As shown in FIG. 7, the panel 700 may permit a user, such as an administrator of an in-application offer system, an offerer (e.g., advertiser), and an offer (e.g., advertisement) account manager, to manage configuration options for identifying client devices in connection with providing in-application offers. As shown, the panel 700 may enable a user to add, remove, or edit options regarding identification of client devices, based on operation system device platform, for offer-serving purposes. The panel 700 may be configured to manage a listing of operating systems or device platforms supported by an in-application offer system, and thereby manage what client devices have access to offers provided by the in-application offer system. Depending on the embodiment, the panel 700 may be accessible through a web-based interface, such as a web site, that may be secured to allow only authorized users access to the panel 700, such as an administrator, an offerer, or an offer account manager. Throughout this description, it will be understood that the administrator, the offerer, or the offer account manage may be an individual associated with the organization operating the in-application system.

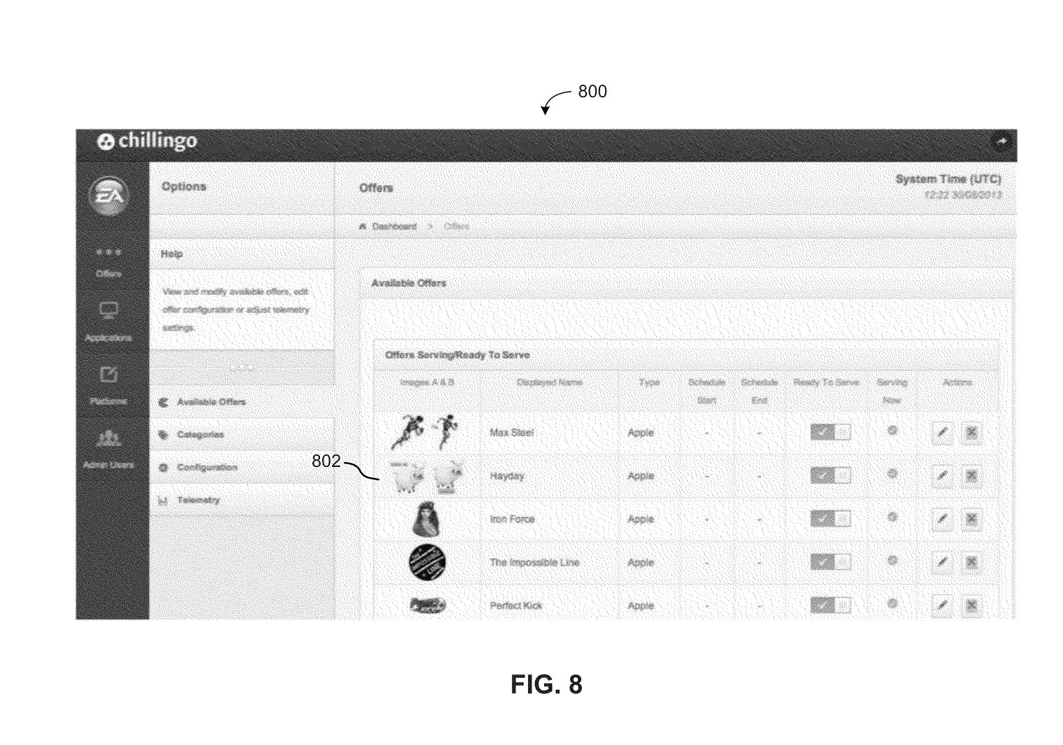

FIG. 8 is a screenshot illustrating an example panel 800 for managing offers in accordance with various embodiments. As shown in FIG. 8, the panel 800 may permit a user, such as an administrator, an offerer, or an offer account manager, to manage offers available for client devices to receive as in-application offers. As shown, the panel 800 may enable a user to add, delete, edit, enable or disable offers that are available for client devices to receive as in-application offers. The panel 800 may present a listing of offers that currently enabled (e.g., by a user) for service to client devices, and may also present a listing of offers currently disabled for services. For a given offer listed, the panel 800 may present a set of graphical assets associated with the given offer. When the given offer is provided to a client device, the client device may receive some or all of the graphical assets in the set. For example, with respect to offer 802 “Hayday,” the panel 800 displays two graphical assets available for use with the offer 802. The panel 800 may also include, for example, a display name for a given offer, the type of the given offer (e.g., device platform or operating system), a schedule start time for serving the offer to client devices, a schedule stop time for serving the offer to client devices, and an indication of the current status of the given offer (e.g., a GUI element indicating enablement and it is being served). In some embodiments, more or less details may be provided with regard to available offers.

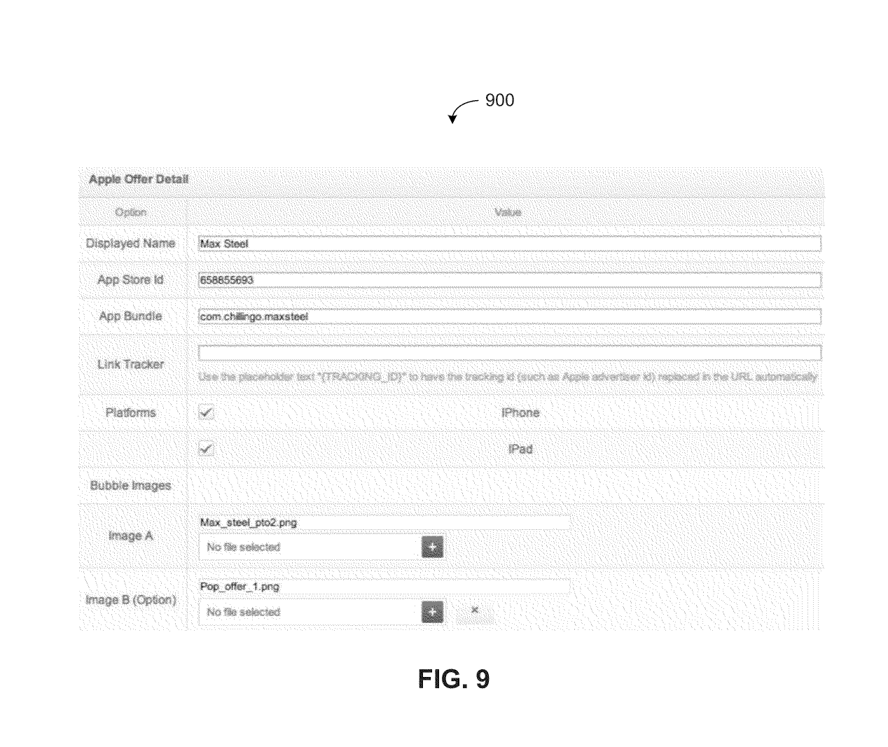

FIG. 9 is a screenshot illustrating an example panel 900 for managing offer details in accordance with various embodiments. As shown in FIG. 9, the panel 900 may permit a user, such as an administrator, an offerer, or an offer account manager, to manage details with regard to an offer that can be provided to a client device as an in-application offer. As shown, the panel 900 may enable a user to add, delete, or edit various details (e.g., properties) regarding the offer. For example, through the panel 900, a user may review or edit the display name of the offer, one or more store identifiers for the application being offered (e.g., Apple® App Store ID, and application bundle ID), an identifier for telemetry tracking (e.g., tracking ID for advertising services), device platform options for the application (e.g., Apple® client devices), and one or more graphical assets (e.g., image files) associated with the offer. For some embodiments, a given offer may have one or more graphical assets designated to be presented during specific conditions. Such specific conditions may be based on the current state, or the user interactions received with respect to, the moving graphical container presenting the given offer (e.g., an image to be presented when the bubble is un-popped, and another image to be presented when the bubble is popped). In some embodiments, more or less details may be provided with regard to a given offer.

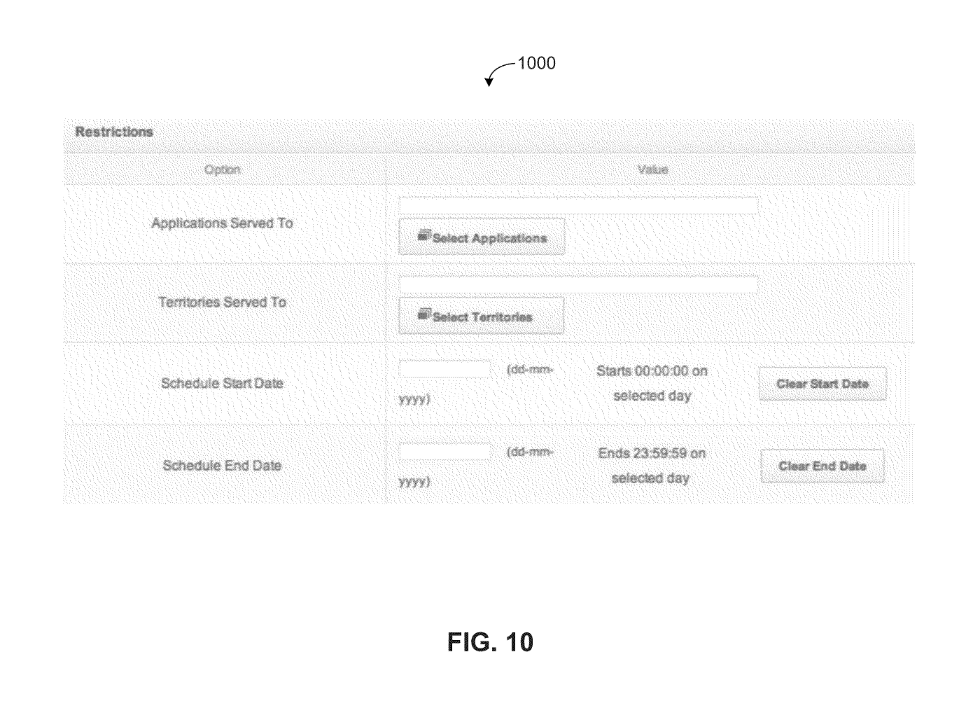

FIG. 10 is a screenshot illustrating an example panel 1000 for managing offer restrictions in accordance with various embodiments. As shown in FIG. 10, the panel 1000 may permit a user, such as an administrator, an offerer, or an offer account manager, to manage with respect to offer that can be provided to a client device as an in-application offer. As shown, the panel 1000 may enable a user to add, delete, or edit various restrictions with respect to the offer. For example, through the panel 1000, a user may review or edit a listing of device, source application, territory, or schedule-based restriction with respect to a given offer. In some embodiments, more or less restrictions may be provided with regard to a given offer.

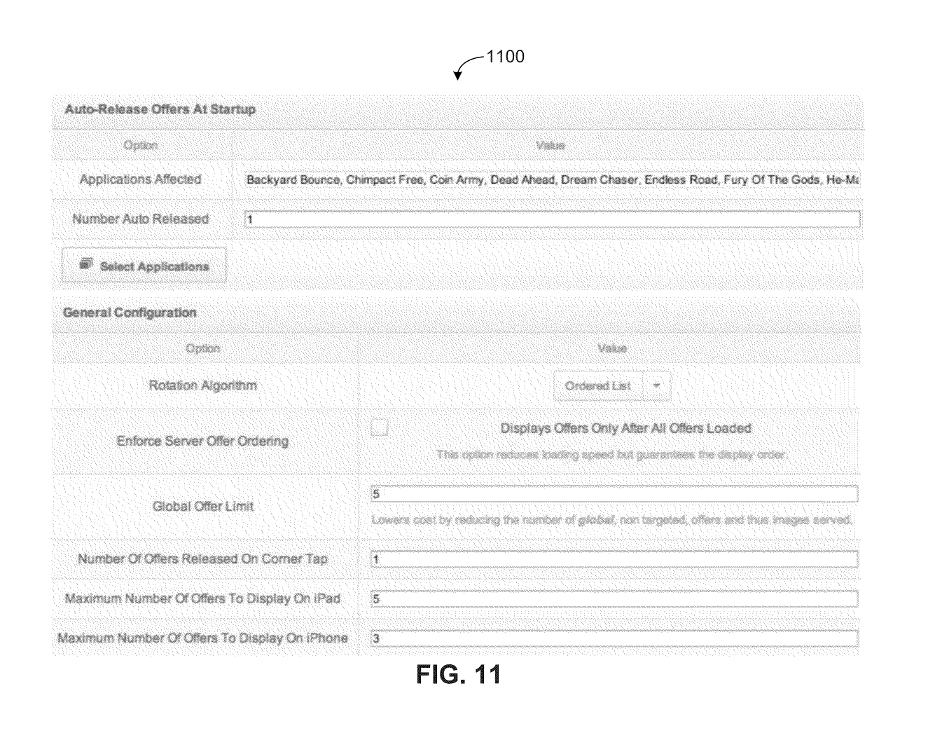

FIG. 11 is a screenshot illustrating an example panel 1100 for managing offer-presentation options in accordance with various embodiments. As shown in FIG. 11, the panel 1100 may permit a user, such as an administrator, an offerer, or an offer account manager, to manage display options with respect to an offer being provided to a client device as an in-application offer. As shown, the panel 1100 may allow a user to add, remove, or edit display options with regard to an offer. For example, through the panel 1100, the user may review or edit a listing for offers that will be auto-released/displayed as in-application offers at the startup of an application (e.g., the application 110), or a value for how many offers will be auto-released/displayed. Through the panel 1100, the user may also select a rotation algorithm that determines how or in what order offers are selected for display at the client device (e.g., round robin), select whether an in-application offer system enforces an order for displaying offers at the client device, or define the maximum limit of offers that can be displayed simultaneously (e.g., according to operating system or device platform). In some embodiments, more or less display options may be provided with regard to available offers.

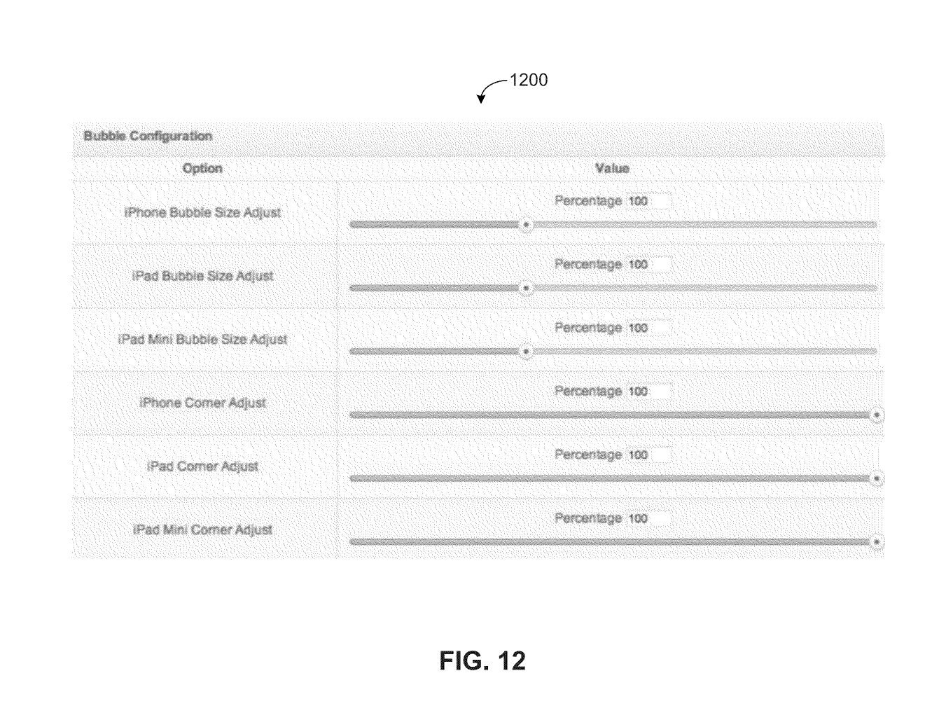

FIG. 12 is a screenshot illustrating an example panel 1200 for managing offer-presentation options in accordance with various embodiments. As shown in FIG. 12, the panel 1200 may permit a user, such as an administrator, an offerer, or an offer account manager, to manage presentation options with respect to an offer being provided to a client device. For example, through the panel 1200, a user may adjust the size or boundaries of graphical containers (e.g., bubbles or snowflakes) used to present offers at the client device. In some embodiments, the presentation options may vary based on the type of graphical container used to present in-application offers. Additionally, presentation options applied to a graphical container may vary based on the offer being presented in the graphical container.

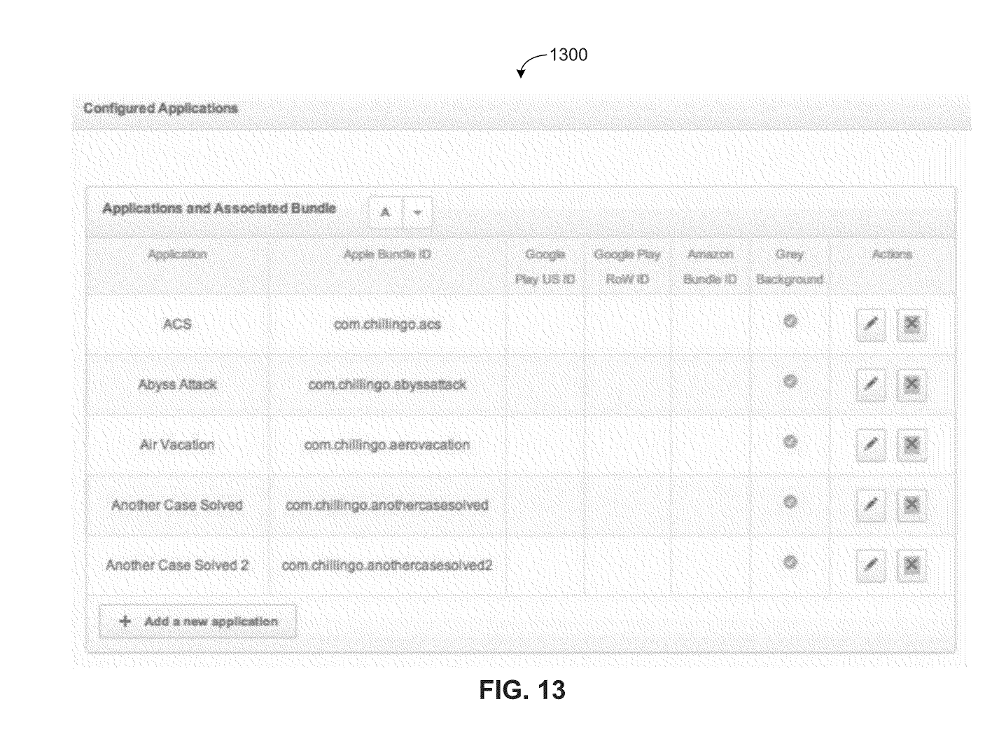

FIG. 13 is a screenshot illustrating an example panel 1300 for managing application offers in accordance with various embodiments. As shown in FIG. 13, the panel 1300 may permit a user, such as an administrator, an offerer, or an offer account manager, to manage (client) applications that may receive offer at the client device and present the offer as an in-application offer on the client device. As shown, a user may add, remove, or edit applications at a given client device that can request and receive (e.g., through an in-application offer SDK) for offers. As shown, for a given application listed, the panel 1300 may list the application name and an application store identifier (e.g., Apple® Bundle ID, Google® Play ID, or Amazon® Bundle ID). In some embodiments, more or less display details may be provided with regard to (client) applications configured to receive offers and present them as in-application offers.

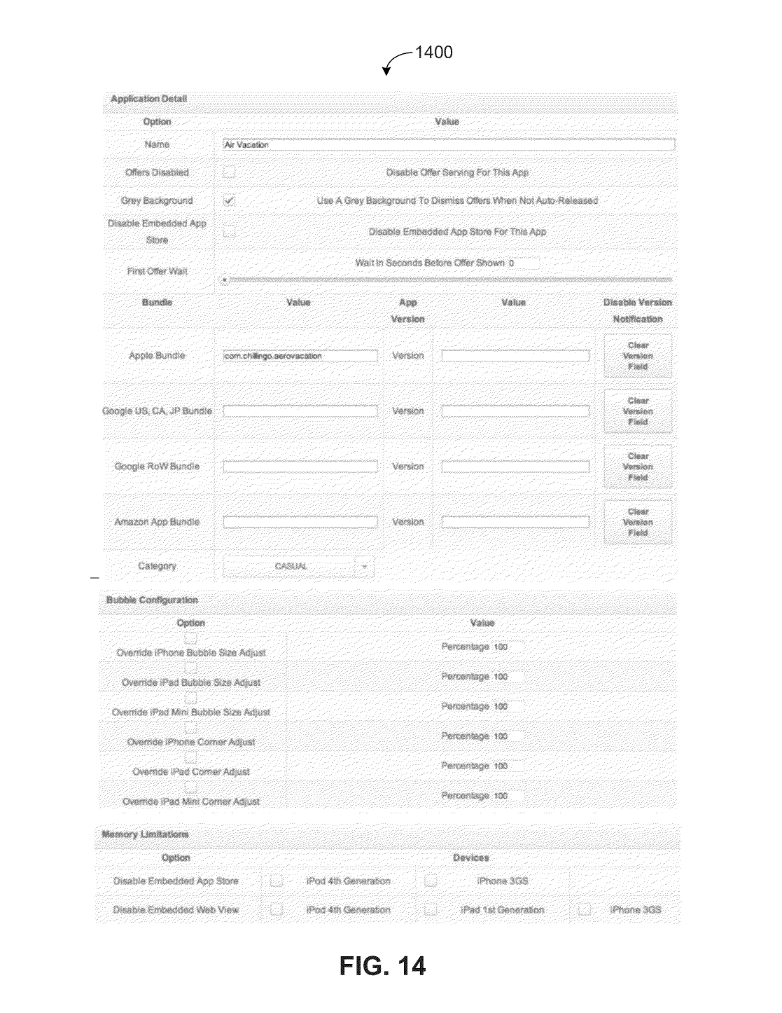

FIG. 14 is a screenshot illustrating an example panel 1400 for managing details regarding an application offer in accordance with various embodiments. As shown in FIG. 14, the panel 1400 may permit a user, such as an administrator, an offerer, or an offer account manager, to manage details with regard to a (client) application that may receive offer at a client device and present the offer as an in-application offer on the client device. As shown, the panel 1400 may enable a user to add, delete, or edit various details (e.g., properties) regarding the application. For example, through the panel 1400, a user may review or edit the application name, an option regarding whether the application is allowed to receive offers (e.g., offers disabled), whether the application uses a grey background to dismiss offers when not auto-released, an option regarding whether the application will utilized embedded application store of the client device (e.g., disable embedded application store), and a delay with respect to the presentation of the first offer. The panel 1400 may also allow the user to review or edit the application store identifiers (e.g., bundle IDs) associated with the application. Further, the panel 1400 may allow the user to override for the application presentation options for graphical containers used to present in-application offers, or limit features of the in-application offers presented with the application. For instance, the panel 1400 may enable the user to disable an in-application offer navigating to an embedded application store or an embedded web page view when the in-application offer is being presented over a certain (client) applications executing on a particular device platform (e.g., Apple® iPod 4^{th} Generation, iPhone® 3 GS, etc.). In doing so, certain embodiments can ensure that presentation and access of in-application offers at a client device do not exhaust computing resources of the client device (e.g., exhaust memory of a memory-constrained device).

In some embodiments, more or less display details may be provided with regard to a (client) application configured to receive offers and present them as in-application offers.

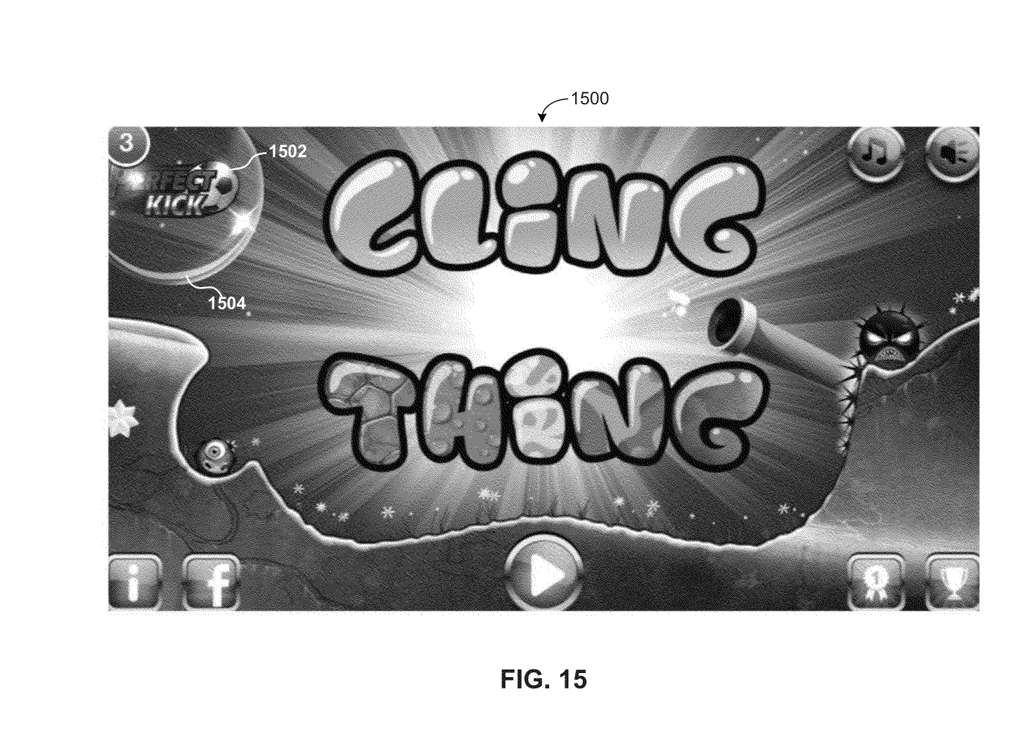

FIGS. 15-17 are screenshots illustrating an example of presenting in-application offers over an application user interface in accordance with various embodiments. In some embodiments, the application user interface may be one associated with an application, such as a video game, that is operating on a mobile device having a touch-enabled display.

In FIG. 15, a game user interface for a video game “Cling Thing” is shown with an in-game offer for “Perfect Kick” being presented over the game user interface 1500 of the video game. As shown, the in-game offer for “Perfect Kick” is visually represented by a graphical asset 1502, which is presented over the game user interface in a graphical container 1504 depicting a bubble. In accordance with various embodiments, the graphical container 1504 may be in motion across the game user interface, may be configured to receive user interactions (e.g., through a touch-enabled display), and may provide a graphical response (e.g., change in movement, pop, bounce) based on the user interactions. As described herein, the graphical container 1504 may be presented through an in-application offer user interface that is overlain over the application user interface (e.g., game user interface) of the application (e.g., the video game).

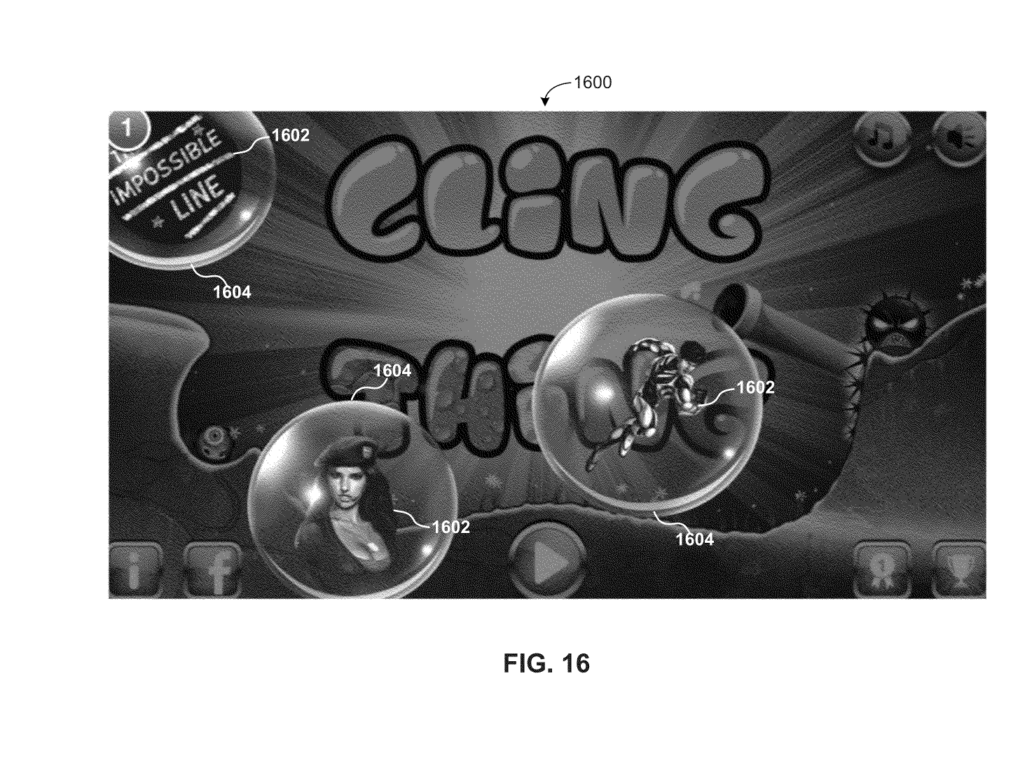

In FIG. 16, the game user interface for a video game “Cling Thing” is shown with multiple in-game offers presented over the game user interface 1600 of the video game. As shown, each in-application offer is represented by a graphical asset 1602 in one of the individual graphical containers 1604 (e.g., bubble). As also shown, the game user interface of the video game is slightly darkened or greyed. For some embodiments, an application user interface (e.g., game user interface) may be darkened or greyed in such a manner when to indicate to a user that they are currently accessing an in-application offer user interface being presented over the application user interface. Based on the access, the user may be able to access the various graphical elements (e.g., graphical containers) being presented by the in-application offer user interface. For example, in FIG. 16, the game user interface may have darkened because the user is dragging-and-dropping one of the graphical containers 1604, or physically moving the mobile device upon which the game user interface and the in-application offer user interface are being displayed. For some embodiments, other adjustments to the appearance of an application user interface (e.g., other overlays) may be utilized to indicate when a user is accessing or interacting with an in-application offer user interface being presented over the application user interface. Access to the in-application offer user interface may be deactivated based on a timer (e.g., no user inputs to the in-application offer user interface for a period of time), or when user interacts with (or attempts to interact with) the application user interface underlying the in-application offer user interface.

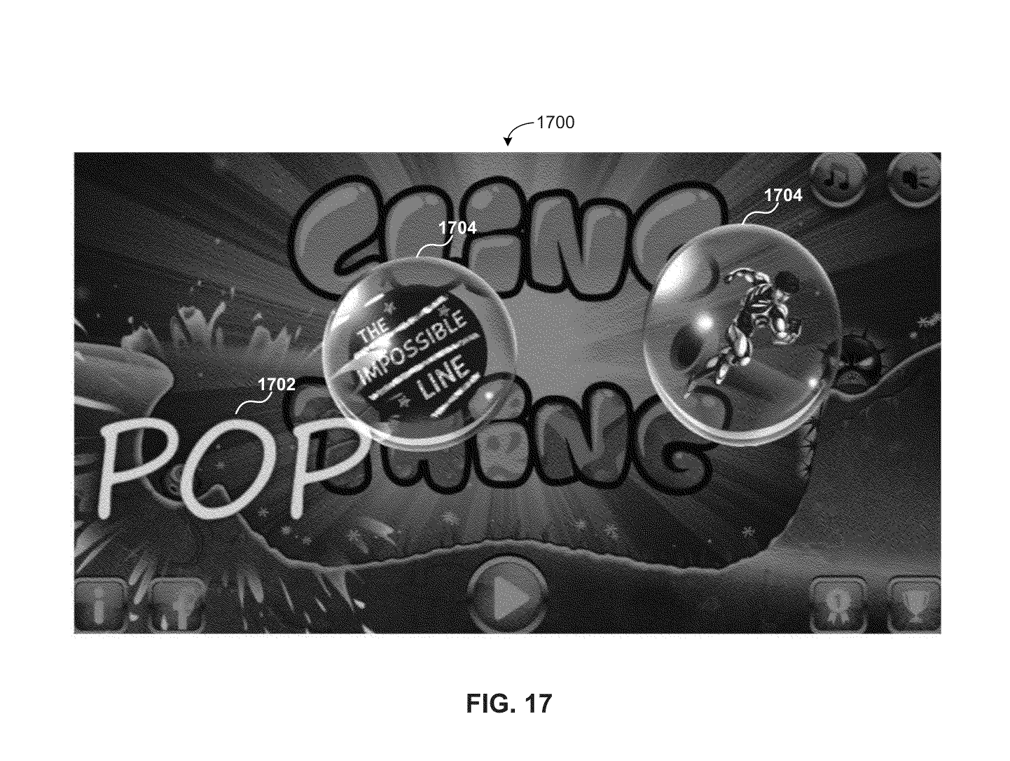

In FIG. 17, the game user interface for a video game “Cling Thing” is shown with multiple in-game offers presented over the game user interface 1700 of the video game. FIG. 17 depicts an example of a graphical response 1702 presented over the game user interface 1700 when a user interacts with one of the graphical containers 1704. For some embodiments, a graphical response presented in response to user interactions may depend on the type of graphical container utilized in the presentation of in-application offers. In FIG. 17, given that the graphical containers 1704 are bubbles and that bubbles have a tendency to pop, a user could have interact with one of the graphical containers 1704 in a certain manner (e.g., tap one of the graphical containers 1704) to cause a graphical response similar to the graphical response 1702, which resembles a bubble popping.

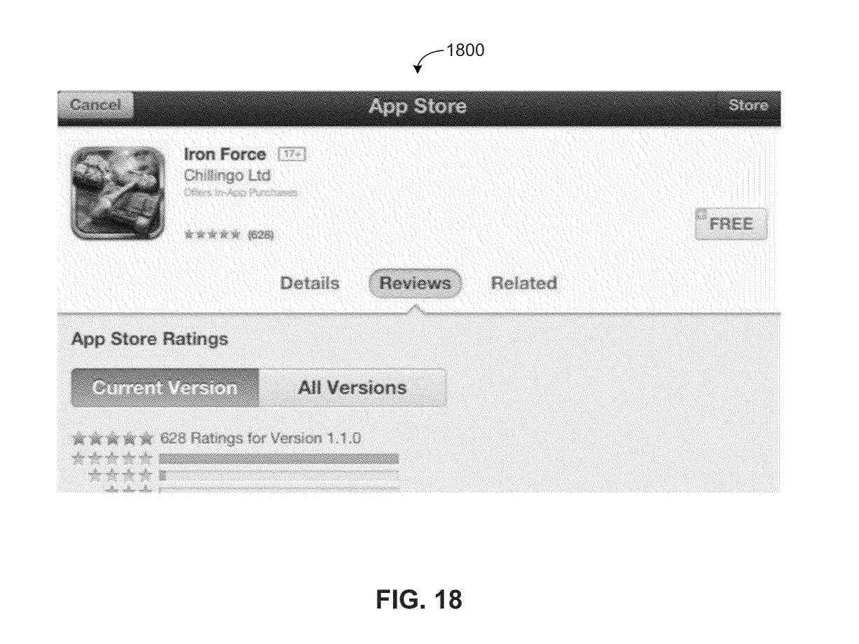

FIG. 18 is a screenshot illustrating an example application store 1800 in accordance with various embodiments. In accordance with some embodiments, when a user interacts with an in-application offer presented at a client device, the user interaction may result in the in-application offer system navigating the user to an application store similar to the one depicted in FIG. 18. For some embodiments, a user interacting with an in-application offer may cause the user to be navigated to an application store based on a link that is associated with (e.g., included with) the in-application offer.

FIG. 19 is a block diagram of an exemplary digital device 1900. The digital device 1900 comprises a processor 1902, a memory system 1904, a storage system 1906, a communication network interface 1908, an I/O interface 1910, and a display interface 1912 communicatively coupled to a bus 1914. The processor 1902 is configured to execute executable instructions (e.g., programs). In some embodiments, the processor 1902 comprises circuitry or any processor capable of processing the executable instructions.

The memory system 1904 is any memory configured to store data. Some examples of the memory system 1904 are storage devices, such as RAM or ROM. The memory system 1904 can comprise the ram cache. In various embodiments, data is stored within the memory system 1904. The data within the memory system 1904 may be cleared or ultimately transferred to the storage system 1906.

The storage system 1906 is any storage configured to retrieve and store data. Some examples of the storage system 1906 are flash drives, hard drives, optical drives, and/or magnetic tape. In some embodiments, the digital device 1900 includes a memory system 1904 in the form of RAM and a storage system 1906 in the form of flash data. Both the memory system 1904 and the storage system 1906 comprise computer readable media which may store instructions or programs that are executable by a computer processor including the processor 1902.

The communications network interface (com. network interface) 1908 can be coupled to a network (e.g., the computer network 104) via the link 1916. The communication network interface 1908 may support communication over an Ethernet connection, a serial connection, a parallel connection, or an ATA connection, for example. The communication network interface 1908 may also support wireless communication (e.g., 802.11a/b/g/n, WiMax). It will be apparent to those skilled in the art that the communication network interface 1908 can support many wired and wireless standards.

The optional input/output (I/O) interface 1910 is any device that receives input from the user and output data. The optional display interface 1912 is any device that is configured to output graphics and data to a display. In one example, the display interface 1912 is a graphics adapter.

It will be appreciated by those skilled in the art that the hardware elements of the digital device 1900 are not limited to those depicted in FIG. 19. A digital device 1900 may comprise more or less hardware elements than those depicted. Further, hardware elements may share functionality and still be within various embodiments described herein. In one example, encoding and/or decoding may be performed by the processor 1902 and/or a co-processor located on a GPU (i.e., Nvidia®).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

Various embodiments are described herein as examples. It will be apparent to those skilled in the art that various modifications may be made and other embodiments can be used without departing from the broader scope of the invention(s) presented herein. These and other variations upon the exemplary embodiments are intended to be covered by the present invention(s).

What is claimed is:

1. A method comprising:
executing an application by a computing device having a screen, the first application having an application user interface being displayed on the screen;
receiving advertisement data and a link to an offer;
displaying the advertisement data in a moving graphical container, the moving graphical container moving across the screen over the application user interface;
awaiting user interaction with respect to the moving graphical container; and
responding to the user interaction by navigating to a page using the link, the page including the offer.

2. The method of claim 1, wherein the responding to the user interaction by navigating to the page using the link comprises responding to the user interaction by navigating to a website accessible by a network, the website including the page.

3. The method of claim 1, wherein the responding to the user interaction by navigating to the page using the link comprises responding to the user interaction by navigating to a page associated with an electronic application store and the offer is associated with one or more applications.

4. The method of claim 1, further comprising receiving an indication to close the page and navigating to the application user interface based on the indication.

5. The method of claim 1, wherein the responding to the user interaction further comprises displaying animation of the graphical container.

6. The method of claim 1, wherein the responding to the user interaction further comprises displaying animation of the advertisement data and the graphical container.

7. The method of claim 1, wherein the advertisement data and the moving graphical container do not interact with the application user interface.

8. The method of claim 1, wherein the advertisement data and the graphical container bounce off of graphical elements of the application user interface.

9. The method of claim 1, wherein the advertisement data and the graphical container avoid portions of the application user interface.

10. The method of claim 1, wherein the advertisement data and the graphical container bounce off another advertisement data and other graphical container.

11. The method of claim 1, further comprising receiving an indication from a user to drag the advertisement data and the graphical container from a first portion of the screen to an other and moving the advertisement data and the graphical container from the first portion of the screen to the other based on the indication.

12. The method of claim 1, wherein the graphical container is a bubble.

13. The method of claim 1, wherein the graphical container is a snowflake.

14. The method of claim 1, wherein the offer includes an invitation to download a game from an electronic application store.

15. The method of claim 1, further comprising receiving a set of advertisements from a network, wherein the advertisement data is a part of the set of advertisements.

16. A system comprising:
an application control module configured to execute an application by a computing device having a screen, the first application having an application user interface being displayed on the screen;
an offer retrieval module configure to receive advertisement data and a link to an offer;
an offer user interface module configured to display the advertisement data in a moving graphical container and await user interaction with respect to the moving graphical container, the moving graphical container moving across the screen over the application user interface; and
an offer action module configured to respond to the user interaction by navigating to a page using the link, the page including the offer.

17. The system of claim 16, wherein the responding to the user interaction by navigating to the page using the link comprises responding to the user interaction by navigating to a website accessible by a network, the website including the page.

18. The system of claim 16, wherein the responding to the user interaction by navigating to the page using the link comprises responding to the user interaction by navigating to a page associated with an electronic application store and the offer is associated with one or more applications.

19. The system of claim 16, further comprising receiving an indication to close the page and navigating to the application user interface based on the indication.

20. The system of claim 16, wherein the responding to the user interaction further comprises displaying animation of the graphical container.

21. The system of claim 16, wherein the responding to the user interaction further comprises displaying animation of the advertisement data and the graphical container.

22. The system of claim 16, wherein the advertisement data and the moving graphical container do not interact with the application user interface.

23. The system of claim 16, wherein the advertisement data and the graphical container bounce off of graphical elements of the application user interface.

24. The system of claim 16, wherein the advertisement data and the graphical container avoid portions of the application user interface.

25. The system of claim 16, wherein the advertisement data and the graphical container bounce off another advertisement data and other graphical container.

26. The system of claim 16, further comprising receiving an indication from a user to drag the advertisement data and the graphical container from a first portion of the screen to an other and moving the advertisement data and the graphical container from the first portion of the screen to the other based on the indication.

27. The system of claim 16, wherein the graphical container is a bubble.

28. The system of claim 16, wherein the graphical container is a snowflake.

29. The system of claim 16, wherein the offer includes an invitation to download a game from an electronic application store.

30. The system of claim 16, further comprising receiving a set of advertisements from a network, wherein the advertisement data is a part of the set of advertisements.

31. A computer readable medium configured to store executable instructions, the instructions being executable by a processor to perform a method, the method comprising:
executing an application by a computing device having a screen, the first application having an application user interface being displayed on the screen;
receiving advertisement data and a link to an offer;
displaying the advertisement data in a moving graphical container, the moving graphical container moving across the screen over the application user interface;
awaiting user interaction with respect to the moving graphical container; and
responding to the user interaction by navigating to a page using the link, the page including the offer.

32. A system comprising:
means for executing an application by a computing device having a screen, the first application having an application user interface being displayed on the screen;
means for receiving advertisement data and a link to an offer;
means for displaying the advertisement data in a moving graphical container, the moving graphical container moving across the screen over the application user interface;
means for awaiting user interaction with respect to the moving graphical container; and
means for responding to the user interaction by navigating to a page using the link, the page including the offer.
